(19) United States
(12) Patent Application Publication
(10) Pub. No.: US 2007/0227212 A1
(43) Pub. Date: Oct. 4, 2007

(54) Materials and methods for preparing dolomite phosphate rock-based soil amendments and fertilizers

(76) Inventors: Zhenli L. He, Fort Pierce, FL (US); Peter Stoffella, Fort Pierce, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/729,521

(22) Filed: Mar. 28, 2007

Related U.S. Application Data
(60) Provisional application No. 60/787,367, filed on Mar. 30, 2006.

(51) Int. Cl. C05D 9/00

(52) U.S. Cl. 71/31

(57) ABSTRACT

The present invention provides compositions and methods for amending the availability of phosphate and other nutrient supplies in soil, especially acidic sandy soils, while ensuring reduced leaching and/or surface runoff of phosphorous and other nutrients. Compositions of the invention comprise granulated dolomite phosphate rock in combination with organic materials, wherein the level and rate of phosphorous and other nutrients released from the composition is controlled. Use of the compositions of the invention increases the availability of phosphorous and other nutrients while eliminating soil acidity, and also stimulates plant growth, enhances plant vigor, and/or improves crop yield.

### CROSS-REFERENCE TO A RELATED APPLICATION

This application claims the benefit of U.S. provisional application Ser. No. 60/787,367, filed on Mar. 30, 2006, which is hereby incorporated by reference in its entirety, including all figures, tables, and drawings.

### BACKGROUND OF THE INVENTION

A number of factors are important in determining the ability of soil to support plant life. Among the crucial factors are the presence of humus and organic matter, together with the availability of essential elements, the ability to retain water, the creation of a good soil structure for microbial activity, cation exchange capacities, sodium absorption ratios, aminization, ammonification, nitrification, pH buffering, and mineralization. To properly support plant life, the organic matter content of the soil must be in the proper ratio to sand, silt, and clay. Cultivation of plants is especially difficult in soils with very low organic matter and nutrients, for example, in areas of southern and central Florida, California, as well as Arizona and Nevada.

Acidity related toxicity and low nutrient availability in acidic soils are also major constraints to plant growth (Baligar et al., “Effect of phosphate rock, coal combustion byproduct, lime and cellulose on plant growth in an acidic soil,” Plant Soil, 195:129-136 (1997)). In Florida, 30% of the soils are acidic with pH below 6.0, where available agricultural land is on extremely sandy soil often characterized by a sand content in excess of 90% (Hoogeweg and Horushy, “Simulated effects of irrigation practices on leaching of citrus herbicides in Flatwoods and Ridge-type soils,” Soil Crop Sci Soc Fla Pro., 56:98-108 (1997); and Potash and Phosphate Institute-Potash and Phosphate Institute of Canada, “Soil test phosphorus, potassium, and pH in North America,” Technical Bulletin of PPI/PPIC, Saskatoon, Canada (1998)).

In recent years, the area of acidic soils in Florida has increased due to the continuous application of acid forming chemical fertilizers, especially in those areas for citrus and vegetable production (He et al., “Effects of nitrogen fertilization of grapefruit trees on soil acidification and nutrient availability in a Reviera fine sand,” Plant Soil, 206:11-19 (1999a)). The acidifying effect of commercially available nitrogen fertilizers is particularly apparent in sandy soils that have a minimal buffering capacity, and this acidification, in turn, enhances phosphorus leaching in sandy soils (He et al., “Sorption, desorption and solution concentration of phosphorus in a fertilized sandy soil,” J. Environ Qual., 28:1804-1810 (1999b)). Therefore, the application of a slow release phosphorus fertilizer and lime is desired for achieving high crop production on most acidic sandy soils in Florida.

Nutrients provided by many commercially available fertilizers are a positive contribution only if the nutrients are retained in the soil for uptake by plants; unfortunately, such nutrients can become environmental pollutants if leached into watercourses or groundwater (Lewis and McGechan, “Simulating field-scale nitrogen management scenarios involving fertilizer and slurry applications,” Paper 98-E-057, Ag Eng 98 Int'l Conference, Oslo (1998); McGechan and Wu, “Environmental and economic implications of some slurry management options,” J Agricult Eng Res., 71:272-283 (1998); and McGechan and Lewis, “Watercourse pollution due to surface runoff following slurry spreading, Part 2: decision support to minimize pollution,” J Agricult Eng Res., 75:417-428 (2000)). For example, much attention has been paid to nitrogen as a nutrient and a pollutant, due to its high solubility and leachability into groundwater (Wu et al., “Parameter selection and testing the soil nitrogen dynamics model SOILIN,” Soil Use Mgmt, 14:170-181 (1998)).

Heavy metal pollution in soils and aquatic system has attracted an increasing attention around the world in recent decades. Due to economic and beneficial disposal of sewage sludge or biosolids, which commonly contain high content of heavy metals, their extensive application in agricultural land can lead to the accumulation of heavy metals in soils (Gendebein, A. et al., “UK Sewage Sludge Survey: National Presentation,” Environment Agency, London (1999); Change A C et al., “Accumulation of heavy metals in sewage sludge treated soils,” J Environ Quality, 13:87-91 (1984); Cornu S et al., “The environmental impact of heavy metals from sewage sludge in ferrasols,” in Armannson, H (Ed.), Geochemistry of the Earth's Surface, Proceedings of the 5^{th} Int'l Symposium, Reykjavik, Iceland. A. A. Balkema, Rotterdam, Netherlands, pp. 169-172 (1999); and Dowdy R H et al., “Trace metal movement in an aeric ochraqualf following 14 years of annual sludge applications,” J Environ Quality, 20:119-123 (1991)). To protect soil quality and ensure sustainability of soil resources, the European Union has set limits for concentrations of individual heavy metals in soils (CEC (Council of the European Communities) “Council Directive of 12 June 1986 on limit values and quality objectives for discharges of certain dangerous substances (86/280/EEC),” Off J Eur Communities, L181:16-27 (1986)).

Meanwhile, aquatic system will also be polluted due to heavy metal leaching from soil to groundwater. Recently, many researchers have more concerns about the leaching of heavy metals from soils amended with sewage sludge (Antoniadis V, Alloway B J, “Leaching of cadmium, nickel and zinc down the profile of sewage sludge-treated soil,” Communications in Soil Science and Plant Analysis, 33:273-286 (2002); Gove L et al., “Movement of water and heavy metals (Zn, Cu, Pb, Ni) through sand and sandy loam amended with biosolids under steady state hydrological conditions,” Bioresource Tech, 78(2):171-179 (2001); Richards B K et al., “Effect of sludge processing mode, soil texture and soil pH on metal mobility in undisturbed soil columns under accelerated leaching,” Environmental Pollution, 109:327-346 (2000); Ashworth D J and Alloway B J, “Soil mobility of sewage sludge-derived dissolved organic matter copper, nickel and zinc,” Environmental Pollution, 127:137-144 (2004); and Sukreeyapongse O et al., “pH-dependent release of cadmium, copper, and lead from natural and sludge-amended soils,” Journal of Environmental Quality, 31:1901-1909 (2002)). The World Health Organization and the European Union have set their own limits for concentrations of individual heavy metals in drinking water.

Recently, investigations have been conducted on the potential contamination of phosphorus to surface water (He et al., “Loading of phosphorus in surface runoff in relation to management practices and soil properties,” Soil Crop Sci Soc. FL, 62:12-20 (2003); Zhang et al., “Release potential of phosphorus in Florida sandy soils in relation to phosphorus fractions and adsorption capacity,” J Environ Sci Heal., A37(5):793-809 (2002); Zhang et al., “Colloidal iron oxide transport in sandy soil induced by excessive phosphorus application,” Soil Sci, 168(9):617-626 (2003); and Zhang et al., “Solubility of phosphorus and heavy metals in potting media amended with yard waste-biosolids compost,” J Environ Qual., 33(1):373-379 (2004)) because phosphorus is a limiting nutrient in most freshwaters (Sharpley and Beegle, “Managing phosphorus for agriculture and the environment,” Coop Ext Serv., Penn State Univ., University Park, (1999)).

Application of phosphorus fertilizers can enhance agricultural production in soils with low phosphorus availability, especially in tropical and subtropical regions. However, phosphorus application in excess of plant requirements often results in contamination of aquatic systems. For example, it has been reported that leaching of phosphorus contributes to eutrophication of fresh water bodies due to the availability of soluble phosphorus to algae (Correl, “The Role of phosphorus in the eutrophication of receiving waters: A Review,” J Environ Qual., 27:261-266 (1998); Daniel et al., “Agricultural phosphorus and eutrophication: A Symposium Overview,” J Environ Qual., 27:251-257 (1998); Grobbelaar and House, “Phosphorus as a limiting resource in inland waters; interactions with nitrogen,” in H. Tiessen (ed.) Phosphorus in the global environment: Transfers, cycles and management John Wiley & Sons, New York, pp. 255-276 (1995); Izuno et al., “Phosphorus concentrations in drainage water in the Everglades Agricultural Area,” J Environ Qual, 20:608-619 (1991); Parry, “Agricultural phosphorus and water quality: A U.S. Environmental Protection Agency Perspective,” J Environ Qual., 27:258-261 (1998); Sharpley et al., “Managing agricultural phosphorus for protection of surface waters: Issues and options,” J Environ Qual., 23:437-451 (1994); Sims et al., “Phosphorus loss in agricultural drainage: Historical perspective and current research,” J Environ Qual., 27:267-276 (1998); and Sonzogni et al., “Bio-availability of phosphorus inputs to lakes,” J Environ Qual., 11:555-563 (1982)). Thus, there has been an increasing interest in developing a slow release phosphorus fertilizer that ensures reduced phosphorus leaching losses from agricultural soils.

Currently available water-soluble phosphorus fertilizers applied to sandy soils, which are widespread in Florida, are readily subjected to leaching, especially during the rainy season. Phosphorus leakage from agricultural soils has been suspected to be one of the major sources for pollution of surface waters (Calvert, “Nitrate, phosphate, and potassium movement into drainage lines under three soil management systems,” J Environ Qual., 4:183-186 (1975); and Calvert et al., “Leaching losses of nitrate and phosphate from a Spodosol as influenced by tillage and irrigation level,” Soil and Crop Sci Soc FL Proc., 40:62-71 (1981)). Therefore, there is an urgent need for new types of phosphorus fertilizers that are agronomically effective and environmentally friendly.

Phosphate rock (PR) has been directly applied to phosphous-deficient acidic soils (Chien and Menon, “Factors affecting the agronomic effectiveness of phosphate rock for direct application,” Fert Res., 41:227-234 (1995); Rajan et al., “Influence of pH, time, and rate of application on phosphate rock dissolution and availability of pasture, I. Agronomic benefits,” Fert Res., 28:85-93 (1991); Wright et al., “The effect of phosphate rock dissolution on soil properties and wheat seeding root elongation,” Plant Soil, 21:21-30 (1991)). Unfortunately, they have not been well accepted because there are several concerns regarding the direct use of PR powders: (1) dusting, which causes potential water contamination of P blown off into the environment; (2) too slow a release of P from the PR in soils with limited acidity sources; and (3) provision of mainly P and Ca, without any nitrogen and organic C, which are also needed for improving plant growth and soil quality (Hughes and Gilkes, “The effect of soil properties and level of fertilizer application on he dissolution of Sechura rock phosphate in some soils from Brazil, Columbia, Australia, and Nigeria,” Aust J Soil Res., 24:219-227 (1986); Kanobo and Gilkes, “The role of soil pH in the dissolution of phosphate rock fertilizers,” Fert Res., 12:165-174 (1987); Robinson and Syers, “A critical evaluation of the factors influencing the dissolution of Gafsa phosphate rock,” J Soil Sci, 41:597-605 (1990); Rajan et al., “Influence of pH, time, and rate of application of phosphate rock dissolution and availability of pasture. I. Agronomic benefits,” Fert Res., 28:85-94 (1991); Bolland et al., “Review of Australian phosphate rock research,” Aust J Exp Agric, 37:845-859 (1997)).

The phosphate industry in Central Florida alone annually produces approximately 800,000 short tons of oversize dolomite phosphate rock (ODPR) at beneficiation sites and greater amounts of ODPR are expected with increasing production capacity. Use of ODPR in the mines through recycling or blending generates minimal revenue. However, ODPR materials contain Ca, Mg, and P nutrients that could be useful for crop production. Analysis of samples taken from a majority of beneficiation sites in Central Florida indicates that the ODPR contains 133 to 237 g kg total P₂O₅, 219 to 433 g kg⁻¹ CaO, 12.6 to 47.8 g kg⁻¹ MgO, and 0.75 to 2.68 g kg⁻¹ K₂O. The calcium carbonate equivalent (CaCO₃ equivalent) of the ODPR materials ranged from 39 to 77% and the higher end is near the best quality of limestone in Florida. Available phosphorus ranged from 37 to 49 g kg⁻¹, which would be an adequate source of phosphorus for plant growth.

Unfortunately, the use of DPR as fertilizers has been limited, if not non-existent, due to a combination of concerns including: concern regarding DPR dust; concern that plants may accumulate heavy metals from the DPR-based fertilizer; runoff of toxic nutrients to surface waters, thus affecting quality of surface water and creating movement of toxic materials from applied field to neighboring community or environment; leaching of chemical from DPR to ground water; and public concern over the environmental impacts of the DPR fertilizers, especially phosphorus leaching from sandy soils.

Despite the numerous fertilizers and soil amendments commercially available, there is still a demand for improved products capable of serving a variety of needs. Insofar as is known, a fertilizer-soil amendment composition comprising dolomite phosphate rock in combination with a particularly effective ratio of biosolids to address phosphorus leaching as well as increase nutrient availability, in addition to several other advantages, has not been previously reported as being useful as a fertilizer/amendment, especially for use with acidic and/or sandy soils.

### BRIEF SUMMARY OF THE INVENTION

The subject invention provides compositions based on wastes from phosphate mining and phosphate-related industries that can be used in both horticulture and agriculture as a fertilizer as well as a soil amendment. In particular, the subject invention provides systems and methods for increasing the availability of nutrients, in particular phosphorus, in acidic soils, preferably sandy acidic soils, without adversely affecting the environment. Contemplated wastes from phosphate mining and phosphate-related industries include, but are not limited to, phosphate rock, oversize dolomite phosphate rock, phosphatic clay, and phosphate fines.

According to one embodiment of the invention, compositions comprising organic materials and phosphate rock or dolomite phosphate rock are added to soil in which plants are grown, wherein the amount of composition added to the soil is effective in providing bioavailable phosphate, as well as other nutrients, to encourage plant survival and growth. The compositions of the invention can be provided in a solid form.

By combining phosphate rock or dolomite phosphate rock materials with organic materials, problems associated with direct use of phosphate rock powders can be overcome. The formulated materials of the invention are easy to apply with minimal dusting as their moisture can be adjusted to an optimal level. The decomposition of organic materials releases organic acids that can maintain a continuous, slow release of phosphorus from the phosphate rock or dolomite phosphate rock. Such compositions can provide not just phosphorus (P) and calcium (Ca), but also nitrogen (N), potassium (K), and other trace elements necessary to promote plant growth and health.

In one embodiment, dolomite phosphate rock and organic materials are combined to produce a mixture that is an acceptable soil amendment and fertilizer. The mixture is particularly advantageous as a soil amendment and fertilizer because it eliminates or significantly reduces many of the undesirable characteristics associated with each material separately (i.e., dolomite phosphate rock and organic materials). The mixture is permitted to incubate at room temperature until it is ready for application to soil.

The quantity of dolomite phosphate rock used in the subject invention's mixtures is based on its sufficiency, in combination with the organic materials, to achieve: adequate supply of P with decreased leaching as compared to existing products such as triple super phosphates or ammonium phosphates; slow release of P into soil to be treated, wherein the P in the mixture is slowly released into soil solution through the availability of soil acidity; increased nutrient availability; decreased phosphorus losses into the environment; reduced odors associated with the organic materials; and increased pH associated with the organic materials.

In a preferred embodiment, the organic material is a fertilizer and/or soil amendment that is produced from sludge by any one or a combination of known methods, such as those disclosed in U.S. Pat. Nos. 6,402,801; 5,749,936; 5,417,861; and 4,554,002. In one embodiment, the organic materials provide liming effects. In preferred embodiments, the organic material comprises certain amounts of N, P, Ca, K, Mg, and trace elements.

More preferably, mixtures of the invention comprise about 70% N-VIRO SOIL™ (N-Viro International Corporation; Toledo, Ohio) soil and about 30% DPR material for application to both citrus and vegetable crop production systems.

According to the subject invention, compositions are provided that can be manufactured using currently available dolomite phosphate rock production facilities, thus reducing costs associated with the manufacture of compositions of the invention.

Preferably, the subject invention provides a safe, cost-effective, and easily monitored process for resolving phosphorus supply to plants in any growth medium. More preferably, the subject invention provides various methods and formulations for the manufacture of a composition containing dolomite phosphate rock and organic materials, wherein controlled release of bioavailable phosphorus and other nutrients are provided by the composition in any soil medium, without the detrimental release of phosphorus and other toxic materials into the environment.

Accordingly, in a specific embodiment, the subject invention provides compositions comprising DPR that have utility both as a fertilizer for promoting growth of plants and as a soil amendment.

Citrus and vegetable crops growth and development are improved with the DPR-based fertilizers of the invention compared to complete water soluble fertilizers on acidic soils, as indicated by higher dry matter yield and improved plant nutrition conditions. The advantages of the DPR fertilizers of the invention over regular water soluble P fertilizers include neutralizing soil acidity, providing Ca, Mg, and micronutrients, and improving soil quality such as raised soil pH, increased nutrient availability, and biological activities.

The compositions of the invention can preferably be applied to soil to reduce soil acidity as well as reduce phosphorous and other nutrient losses into the environment due to leaching and/or surface runoff.

The compositions of the invention can be used for agricultural production systems (such as citrus and vegetable production systems) as well as landscapes, lawns, and containerized media (such as potted plants).

### BRIEF DESCRIPTION OF THE FIGURES

FIGS. 1a and 1b are graphical illustrations of the dynamic change of total P concentration in leachate from sandy soil amended with water-soluble P fertilizer or DPR fertilizers.

FIGS. 2a and 2b are graphical illustrations of cumulative P leached (percentage of P added) from sandy soil amended with water-soluble P fertilizer or DPR fertilizers.

FIG. 3 is a graphical illustration of the dynamic changes of leachate Cu concentrations for soil amendments containing various percentages of DPR.

FIG. 4 is a graphical illustration of the dynamic changes of leachate Zn concentrations for soil amendments containing various percentages of DPR.

FIG. 5 is a graphical illustration of total Cu losses for soil amendments containing various percentages of DPR.

FIG. 6 is a graphical illustration of the total Zn losses for soil amendments containing various percentages of DPR.

FIGS. 7a and 7b are illustrations of auto-samplers installed for collecting surface runoff and seepage from citrus beds.

FIG. 8 is an illustration of solar panels used to power the auto-samplers of FIGS. 7a and 7b.

FIGS. 9a and 9b are illustrations of auto-samplers installed for collecting surface runoff and seepage from vegetable fields.

FIG. 10 is an illustration of two auto-samplers housed in the same shade, wherein one auto-sampler was used for a DPR soil amendment treated plot and the other for the control plot.

FIG. 11 is an illustration of a computing means of an auto-sampler.

FIG. 12 is an illustration of a Doppler sensor and pump tubing installed at the end of a drainage pipe to trigger sampling process and to record discharge rate of surface runoff from monitored fields.

FIG. 13 is an illustration of samples bottles of surface runoff collected at the base of the auto-samplers.

FIG. 14 is an illustration of ground DPR material (<100 mesh) that is used in accordance with the present invention.

FIG. 15 is an illustration of one method for mass production of DPR soil amendment prepared in accordance with the present invention.

FIG. 16 is an illustration of one embodiment of the invention, namely DPR soil amendment comprising DPR and organic biosolids.

FIGS. 17a and 17b are illustrations of methods for transporting a DPR soil amendment of the invention to an area for treatment.

FIGS. 18a and 18b are illustrations of methods for applying DPR soil amendment of the invention to an area.

FIG. 19 is an illustration of minimal dusting of DPR soil amendment on leaves and surrounding ground of citrus plants.

### DETAILED DESCRIPTION OF THE INVENTION

The present invention provides compositions and methods that increase the amount of available phosphorus and other nutrients to plants in any growth medium, including acidic, sandy soil. The compositions of the invention preferably comprise a mixture of phosphatic wastes generated from phosphate mining and/or phosphate-related industries and an organic material, where the phosphatic wastes serve to neutralize soil pH while sustaining optimum yields of phosphorus in the soil.

According to the present invention, phosphatic wastes generated from phosphate mining and/or phosphate-related industries that can be mixed with organic material include, but are not limited to, phosphate rock, dolomite phosphate rock, phosphatic clay, and phosphate fines.

The compositions of the present invention are particularly useful not only in increasing the bioavailability of phosphorus, but also increasing the availability of other nutrients in the organic materials, without any detrimental environmental effects. Further, the compositions of the invention have minimal unwanted odor and present a favorable pH. Accordingly, the compositions of the invention are particularly advantageous in stimulating plant growth, enhancing plant vigor, and/or improving crop yield.

In operation, the compositions of the invention are applied to the plant, seed, or plant growth medium either before, during, or after the plant has been introduced to a growth medium. Plant growth medium include soils and potting media. Methods according to the invention involve the application of dry formulations of the compositions of the invention. Preferably, the compositions of the invention are applied to the base of the plant or on the plant growth medium.

Optionally, one or more of the following ingredients can be added to the DPR and/or organic material in the preparation of compositions of the invention: companion cations; cation reducing agents; pH modulating compounds; plant nutrients; organic compounds; macronutrients; micronutrients; penetrants; beneficial microorganisms; soil or plant additives; pesticides; fungicides; insecticides; nematicides; herbicides; growth materials; and the like.

In a preferred embodiment of the invention, approximately 20-50% of the mixture is composed of dolomite phosphate rock and about 50-80% of the mixture is the organic material. The organic materials that can be mixed with dolomite phosphate rock in accordance with the present invention include, but are not limited to, materials such as livestock and poultry manure, sewage sludge, humic acid, fulvic acid, seaweed extracts, kelp extracts, municipal and other organic composts. In certain embodiments of the invention, the organic materials comprise a ratio of 1:1 sewage sludge (or other forms of human, animal, and poultry waste) to fly ash or other pH modifying material such as calcium sulphate.

According to the subject invention, plant nutrients that can be added include macronutrients such as nitrogen (N), phosphorus (P), potassium (K), secondary nutrients such as calcium (Ca), magnesium (Mg), and micronutrients such as Iron (Fe), zinc (Zn), manganese (Mn), copper (Cu), and boron (B). Any combination of plant nutrients, macronutrients, secondary nutrients, and/or micronutrients can be used in the preparation of the compositions according to the subject invention.

Microorganisms useful in the practice of the invention can be selected from one or more of bacteria, fungi, and viruses that have utility in soil enhancement. For example, P-dissolving bacteria (such as Enterobacter cancerogenus, Klebsiella oxytoca, Citrobacter werkmanii, Citrobacter freundii, Enterobacter aerogenes, Salmonella enterica, Bacillus megaterium I and II, and Enterobacter cloacae), rhizobia bacteria, thiobacillus, P-solubilizing fungi (such as Acaulospora foveata, Acaulospora mellea, Acaulospora scrobiculata, Acaulospora leptoticha, Glomus etunicatum, Glomus geosporum, Glomus macrocarpum, and Scutellospora weresubiae), and mycorrhizal fungi, are examples of useful in soil enhancement. Any combination of one or more microorganisms may be used in the practice of the subject invention.

Microorganisms (bacteria, fungi and viruses) that control various types of pathogens in the soil include microorganisms that control soil-born fungal pathogens, such as Trichoderma sp., Bacillus subtilis, Penicillium spp.; microorganisms that control insects, such as Bacillus sp., e.g., Bacillus popalliae; microorganisms that act as herbicides, e.g., Alternaria sp., and the like. These organisms are readily available from public depositories throughout the world.

Non-limiting examples of beneficial microorganisms that can, optionally, be added to the compositions of the invention to enhance the quality of soil for the growth of plants include: microorganisms of the genera Bacillus, for example B. thurigensis; Clostridium, such as Clostridium pasteurianum; Rhodopseudomonas, such as Rhodopseudomonas capsula; Rhizobium species that fix atmospheric nitrogen; phosphorous stabilizing Bacillus, such as Bacillus megaterium; cytokinin producing microorganisms such as Azotobacter vinelandii; Pseudomonas, such as Pseudomonas fluorescens; Athrobacter, such as Anthrobacter globii; Flavobacterium such as Flavobacteriium spp.; and Saccharomyces, such as Saccharomyces cerevisiae, and the like. The number of microorganisms that can be used in the practice of the subject invention can range from about 10⁵ to 10¹⁰ organisms per gram of composition.

Optional soil and/or plant additives that can be added to the compositions of the invention include water trapping agents, such as zeolites; natural enzymes; growth hormones (such as the gibberellins, including gibberellic acid and gibberellin plant growth hormones); and control agents, including pesticides such as acaracides, molluskicides, insecticides, fungicides, nematocides, and the like.

The compositions of the invention may be applied in the form of wettable powders, granules (slow or fast release) or controlled release formulations such as microencapsulated granules.

Granules or aggregates of mixtures of the invention are formed by: (1) grinding and passing through a 50-150 mesh the dolomite phosphate rock; and (2) mixing the organic materials with the ground dolomite phosphate. In a method of use, once the mixtures of the inventions are formed, the mixtures are applied to the field to enhance plant health and growth.

As indicated above, the compositions produced according to the present invention are usually applied to the soil or to the potting media. The compositions of the invention may be used advantageously on many types of agricultural and horticultural crops, including but not limited to, cereals, legumes, brassicas, cucurbits, root vegetables, sugar beet, grapes, citrus and other fruit trees and soft fruits. More particularly, crops that will benefit from the compositions include, but are not limited to, corn, peas, oil seed rape, carrots, spring barley, avocado, citrus, mango, coffee, deciduous tree crops, grapes, strawberries and other berry crops, soybean, broad beans and other commercial beans, tomato, cucurbitis and other cucumis species, lettuce, potato, sugar beets, peppers, sugar cane, hops, tobacco, pineapple, coconut palm and other commercial and ornamental palms, rubber and other ornamental plants.

A preferred mixture of the invention comprises proper proportions of N-VIRO SOIL™ (N-Viro International Corporation, Toledo, Ohio) to DPR at a proportion of 50-80% N-VIRO SOILTM to 20-50% DPR. The resultant materials contain (g kg⁻¹): total organic C 44-79, total N 3.6-6.5, total P 16-59, total K 2-3, total Ca 120-190, and total Mg 3-8, and can be used as P slow release fertilizers and/or soil amendments in citrus and vegetable crop production systems. Such DPR fertilizers developed can provide adequate P, Ca, Mg, and micronutrients for optimal growth of citrus or vegetable crops.

Following are examples which illustrate procedures for practicing the invention. These examples should not be construed as limiting. All percentages are by weight and all solvent mixture proportions are by volume unless otherwise noted.

### EXAMPLE 1

### Materials and Methods

### Soil and N-VIRO-SOIL™-Based DPR Fertilizers

A typical acidic sandy soil (Wabasso sand 96.1%, silt 2.3%, and clay 1.6%) classified as hyperthermic Alfic Haplaquods, was collected at the 0-30 cm depths in Fort Pierce, Fla. Wabasso sand is a representative agricultural soil of commercial citrus and vegetable production systems in the Indian River area. Selected properties of the soil were 5.0 g kg⁻¹ organic C, 0.23 g kg⁻¹ total N, pH 4.1 (1:1 H₂O), pH 3.2 (1:1 KCl), 5.1 mg NaOH extractable P kg⁻¹ soil, 0.6 mg Olsen-P kg⁻¹ soil.

The DPR source selected for this study was from an IMC facility in Central Florida because of its relatively higher concentrations and availability of phosphorus (P) and other nutrients such as Ca and Mg than other DPR sources. The N-VIRO SOIL™ was provided by the Florida division of N-Viro International Corporation, L. P. Company. N-VIRO SOIL™ is composed of biosolids and fly ash (1:1) and has been increasingly used in citrus groves, gardens, and vegetable fields in Florida and other states in the USA. The DPR was ground to <100 mesh and then mixed with N-VIRO SOIL™ at proportions of 0, 10, 20, 30, 40, 50, and 100% DPR. The DPR/N-VIRO SOIL™ mixtures of the invention were incubated at room temperature for 10 days prior to use. Some chemical properties and nutritional values of these DPR/N-VIRO SOIL™ mixtures are presented in Table 1.

Total C and N in the DPR/N-VIRO SOIL™ mixtures were determined by dry combustion using a CN analyzer (Vario Max CN, Macro Elemental Analyzer System GmbH, Hanau, Germany). The pH was measured in water at the solid:water ratio of 1:2 (w:w) using a pH/ion/conductivity meter (Accumet Model 50, Fisher Scientific Inc. Atlanta, Ga.). Electrical conductivity (EC) was measured in solution at a solid:water ratio of 1:2 using a pH/ion/conductivity meter (Accumet Model 50, Fisher Scientific Inc. Atlanta, Ga., USA). Available P was extracted using either 0.5 M NaHCO₃ or Mehlich I reagent and P concentration in the extract was determined by the molybdenum-blue method (Olsen and Sommers, 1982). Total concentrations of P, Ca, and Mg in the DPR IN-VIRO SOIL™ mixtures were determined using an Inductively Coupled Plasma Atomic Emission Spectrometry (ICPAES, Ultima, JY Horiba Inc., Edison, N.J., USA) following digestion with aqua regia and hydrofluoric acid (Hossner, 1996).

### Column Leaching Experiment

A column leaching study was conducted using 27 plastic columns (6.6 cm inner diameter and 30.5 cm long) with leaching solution delivered by a peristaltic pump (PumpPro MPL, Watson-Marlow, Inc., Wilmington Mass., UK). Each column was fitted with a fine netting at its bottom for leachate to pass through and to prevent soil loss.

Soil (1 kg oven-dried basis) was amended with different DPR/N-VIRO SOIL™ mixtures, pure DPR or N-VIRO SOIL™, or water-soluble P fertilizer, and then packed into the column. The treatments included: (1) control without any DPR/N-VIRO SOIL™ mixture, (2) the DPR IN-VIRO SOIL™ mixtures with proportion of DPR at 0, 10, 20, 30, 40, 50, and 100%, respectively, and (3) water-soluble P fertilizer with P from NaH₂PO₄. The DPR/N-VIRO SOIL™ mixtures were added to soil at 1% (w/w) and water-soluble P fertilizer was added with an amount of P equivalent to available P in the 25% DPR IN-VIRO SOIL™ mixture. Each treatment was replicated three times. Soil columns were leached with deionized water. Leaching was conducted once per week for ten times. For each leaching, 118.3 mm of deionized water was used with the total leaching volume equivalent to the average annual rainfall (1183 mm) in the last few years. Leachate samples from each leaching event were collected and filtered through a Whatman 42 filter paper prior to analysis for reactive P and total P. Reactive P was determined using the molybdenum-blue colorimetry (Kuo, K., “Phosphorus,” In D. L. Sparks (ed.) Methods of soil analysis. Part 3. SSSA Book Series no. 5. SSSA. Madison. Wis., pp. 869-919, 1996) and the leachate was digested with acidified ammonium persulfate for total P analysis (Greenberg, A. E., Standard methods for the examination of water and wastewater. American Public Health Association, Washington, D.C., 1992).

### Results and Discussion

Characteristics of the DPR-Based Fertilizers/Soil Amendments Incorporation of DPR materials up to 50% did not affect good aggregation structure of the N-VIRO SOIL™ products. Furthermore, addition of DPR above 20% significantly reduced odors of the N-VIRO SOIL™ products. The nutrient composition and relevant properties of the newly developed DPR/N-VIRO SOIL™ mixtures are presented in Table 1. The N-VIRO SOIL™ by itself had a high pH (11.7). Incorporation of the DPR materials decreased pH from 11.7 to 10.4, which is more favorable to crop growth. Addition of the DPR materials with N-VIRO SOIL™ also significantly increased total and available contents of P and Mg and CaCO₃ equivalent, and thus increased liming capacity and nutrient supplying ability of the products, which makes the products more effective combined than separately in eliminating soil acidity and increasing P and Mg availability. There were some positive interactions between the N-VIRO SOIL™ and the DPR materials, as evidenced by the increased available P determined by Olsen method (Table 1). This effect is probably related to an enhanced dissolution of P from the DPR materials by organic matter from the N-VIRO SOIL™.

TABLE 1
Relevant properties of tested DPR/N-VIRO SOIL ™ mixtures

| DPR-based fertilizers | pH | Total C | Total N | Total P | Total Mg | CaCO₃ | Olsen-P | Mehlich-1P |
|---|---|---|---|---|---|---|---|---|
| with DPR % | (H₂O) | (g kg⁻¹) | (g kg⁻¹) | (g kg⁻¹) | (g kg⁻¹) | (%) | (mg kg⁻¹) | (g kg⁻¹) |
| 0 | 11.7 | 88.2 | 7.24 | 4.93 | 1.96 | 25.3 | 326 | 0.21 |
| 10 | 11.5 | 79.4 | 6.52 | 15.7 | 2.56 | 29.7 | 546 | 1.38 |
| 20 | 11 | 70.6 | 5.79 | 26.4 | 3.16 | 34.1 | 608 | 3.60 |
| 30 | 10.7 | 61.8 | 5.07 | 37.2 | 3.77 | 38.6 | 583 | 4.64 |
| 40 | 10.5 | 52.9 | 4.34 | 47.9 | 4.37 | 43.0 | 528 | 5.21 |
| 50 | 10.4 | 44.1 | 3.62 | 58.7 | 4.97 | 47.4 | 527 | 6.31 |
| 100 | 7.2 | 0.00 | 0.00 | 112.4 | 7.98 | 69.5 | 307 | 21.20 |

### Environmental Impact of P Leaching in Sandy Soil

As noted above, sandy soils, commonly characterized by their low content of P-retaining soil constituents (clay, organic matter, and oxides of Fe and Al), are readily subjected to P leaching loss, especially when applied with water-soluble P fertilizers (Elliott, H. A. et al., “Phosphorus leaching from Biosolids-amended sandy soils,” Journal of Environmental Quality, 31:681-689 (2002); Fox, R. L. and Kamprath, E. J., “Adsorption and leaching of P in acid organic soils and high organic matter sand,” Soil Science Society of American Proceedings, 35:154-156 (1971); Neller, J. R., “Mobility of phosphates in sandy soils,” Soil Science Society of American Proceedings, 11:227-230 (1946); Summers et al., “Comparison of single superphosphate and superphosphate coated with bauxite residue for subterranean clover production on phosphorus-leaching soils,” Australian Journal of Soil Research, 38:735-744 (2000)).

In this study, a typical sandy soil of Florida amended with water-soluble P fertilizer resulted in 96.6% of total added P leached after ten leaching events (Table 3). Moreover, 98.8% of leached P occurred in the first three leaching events. This result indicates that P leaching in sandy soils is extremely severe and may have a great impact on the environment. Phosphorus leached from soils consists of reactive P and non-reactive P. Reactive P readily causes eutrophication of aquatic system due to its availability to algae. In this study, reactive P accounted for 67.7-99.9% of the total leachate P for each leaching event (Table 2), indicating that leached P was dominantly reactive. These results were consistent with those reported by Elliott, H. A. et al., supra (2002) from two acidic sandy soils amended with eight biosolids. The dominant reactive P in the leachate is likely related to very low content of organic matter in the soil used in this study, for the DPR/N-VIRO SOIL™ mixtures applied to the soil only accounted for a very small proportion of the soil although they contain relatively high organic matter, with the exception of 100% DPR treatment that contained no organic matter. Higher percentages of reactive P in leachate P imply that it is especially important to control P leaching loss in the sandy soils.

TABLE 2
Percentages of reactive P in total P leached for each leaching event during the entire study period

| | 1st | 2nd | 3rd | 4th | 5th | 6^{th} | 7th | 8th | 9th | 10th |
|---|---|---|---|---|---|---|---|---|---|---|
| Treatments | % | | | | | | | | | |
| 100% DPR + 0% N-VIRO SOIL ™ | 98.2 | 83.9 | 87.5 | 96.6 | 95.7 | 97.7 | 89.5 | 89.8 | 78.4 | 82.7 |
| 50% DPR + 50% N-VIRO SOIL ™ | 94.4 | 81.1 | 87.2 | 94.3 | 87.7 | 88.1 | 80.6 | 73.2 | 70.5 | 73.7 |
| 40% DPR + 60% N-VIRO SOIL ™ | 93.8 | 80.0 | 83.5 | 92.9 | 84.9 | 87.6 | 82.1 | 78.2 | 77.5 | 81.4 |
| 30% DPR + 70% N-VIRO SOIL ™ | 90.1 | 81.8 | 83.3 | 95.7 | 85.2 | 87.0 | 81.3 | 77.1 | 77.0 | 79.5 |
| 20% DPR + 80% N-VIRO SOIL ™ | 89.3 | 84.0 | 82.3 | 90.6 | 87.3 | 88.5 | 83.8 | 77.6 | 76.3 | 81.9 |
| 10% DPR + 90% N-VIRO SOIL ™ | 90.0 | 84.0 | 85.3 | 91.2 | 86.7 | 90.0 | 79.4 | 74.6 | 73.5 | 75.7 |
| 0% DPR + 100% N-VIRO SOIL ™ | 88.0 | 82.0 | 83.8 | 88.2 | 82.3 | 84.6 | 78.2 | 78.0 | 77.2 | 76.2 |
| NaH₂PO₄ | 99.9 | 91.1 | 90.0 | 97.4 | 80.7 | 83.7 | 73.9 | 71.6 | 67.7 | 79.9 |
| Control | 91.4 | 81.0 | 78.8 | 83.6 | 78.3 | 81.9 | 71.2 | 80.2 | 68.1 | 80.8 |

TABLE 3
Amounts of P leached from the soil amended with various P sources after ten leaching events

| | Total P leached | P leached | Reactive P leached |
|---|---|---|---|
| Treatments | (mg) | (% of total P added) | (% of total P leached) |
| 100% DPR + 0% N-VIRO SOIL ™ | 5.01 ± 0.59 | 0.45 ± 0.05 | 95.3 ± 2.8 |
| 50% DPR + 50% N-VIRO SOIL ™ | 1.87 ± 0.24 | 0.32 ± 0.04 | 87.7 ± 4.6 |
| 40% DPR + 60% N-VIRO SOIL ™ | 1.83 ± 0.13 | 0.38 ± 0.03 | 87.4 ± 2.5 |
| 30% DPR + 70% N-VIRO SOIL ™ | 1.78 ± 0.07 | 0.48 ± 0.02 | 86.1 ± 1.4 |
| 20% DPR + 80% N-VIRO SOIL ™ | 1.92 ± 0.15 | 0.73 ± 0.06 | 85.5 ± 2.2 |
| 10% DPR + 90% N-VIRO SOIL ™ | 1.72 ± 0.09 | 1.10 ± 0.06 | 85.3 ± 4.0 |
| 0% DPR + 100% N-VIRO SOIL ™ | 1.87 ± 0.17 | 3.79 ± 0.35 | 84.5 ± 5.9 |
| NaH₂PO₄ | 51.13 ± 4.12 | 96.59 ± 7.78 | 92.6 ± 3.2 |
| Control | 1.74 ± 0.15 | NA^{a} | 92.8 ± 13.9 |

^{a}Not applicable

### Comparison of P Leaching From the Soil Amended With the DPR Fertilizers and Water-Soluble P Fertilizer

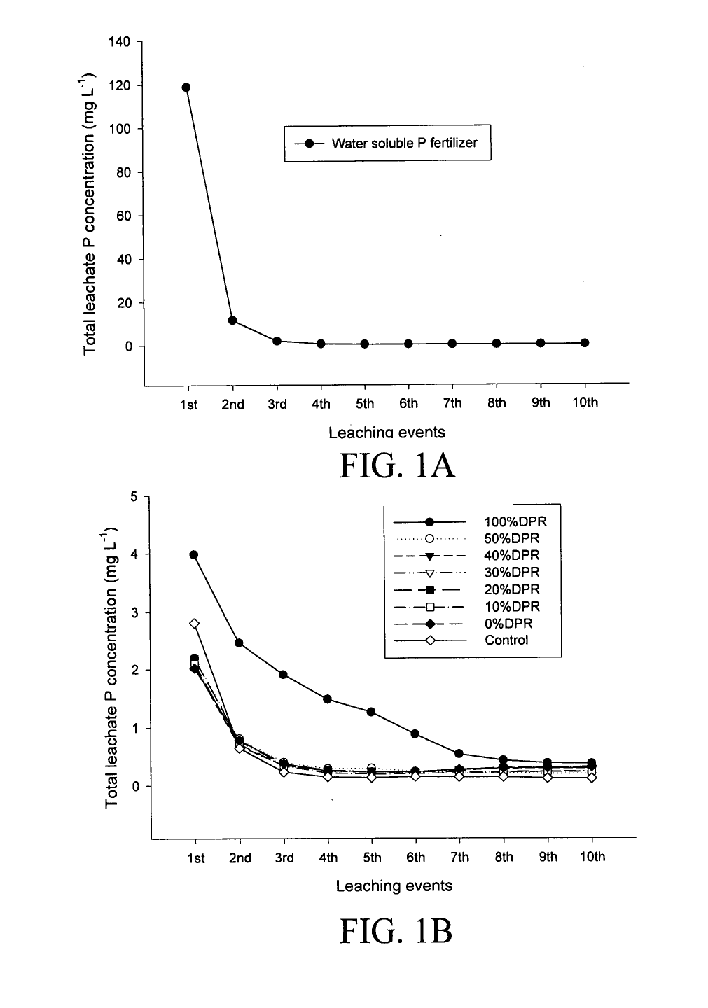

The concentrations of leachate P from the first leaching event were significantly higher than those from any subsequent leaching event for all the treatments. The greatest P loss occurred in the first leaching event and accounted for 30.6-89.42% of total P leached over the whole study period (FIG. 1). Leachate P concentration decreased with increasing leaching events and reached a relatively stable level after four leaching events (FIG. 1) (the concentrations of leachate P for the soil amended with water-soluble P were so substantially higher than those for other treatments in the first three leaching events that we had to present them separately (FIGS. 1a and 1b) in order to show the differences in leachate P among the different DPR/N-VIRO SOIL™ mixture treatments.

The concentrations of P leached from the soil amended with water-soluble P fertilizer were significantly higher than those amended with the DPR/N-VIRO SOIL™ mixtures in the first two leaching events (ranging from 118.7 to 11.5 mg/L for water-soluble P fertilizer and from 4.0 to 0.5 mg/L for different DPR/N-VIRO SOIL™ mixtures and control). Moreover, P concentrations in the leachate from the water-soluble fertilizer treatment were still higher than those from other treatments except for the 100% DPR treatment until the 4^{th} leaching event, whereas those DPR treatments already resulted in leachate P concentrations close to the surface water standard of 0.1 mg/L established by USEPA (1987). These results indicate that DPR/N-VIRO SOIL™ mixtures were more environmentally friendly than the water-soluble P fertilizer as they resulted in much less P leaching from the sandy soil.

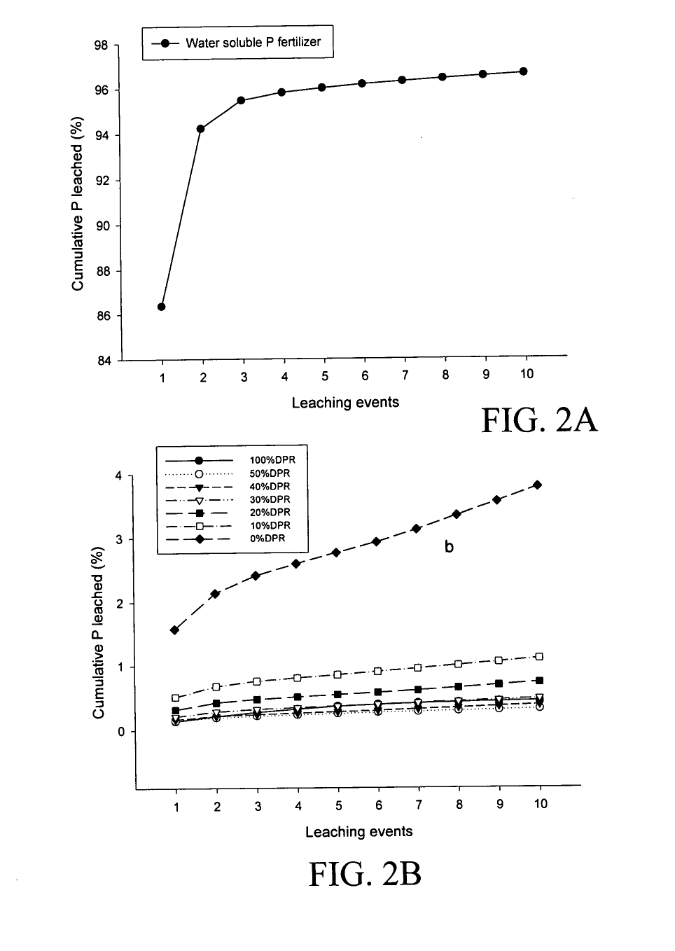

In the 5^{th} leaching event, leachate P from the treatment of water-soluble P fertilizer was lower than those from the treatments of 50% DPR and 100% DPR/N-VIRO SOIL™ mixtures, but still higher than those from other treatments. After six leaching events, leachate P from the soil amended with water-soluble P fertilizer was lower than those from all the DPR treatments but was close to that from the control (FIGS. 1 and 2) because P amended to soil in water-soluble P fertilizer was quickly leached out, whereas the soils amended with different DPR/N-VIRO SOIL™ mixtures or N-VIRO SOIL™ retained most applied P that is slowly released and not subjected to intensive leaching.

Among the DPR/N-VIRO SOIL™ mixture treatments, 100% DPR treatment caused significantly higher leachate P concentration due to a larger amount of total P added to the soil. Leachate P concentration from this treatment remained relatively high up to the 10^{th} leaching event and was approximately 1.2-1.9 times higher than those from other DPR/N-VIRO SOIL™ mixture treatments. Leachate P concentration among the treatments of 0%, 10%, 20%, 30%, 40% and 50% DPR was not significantly different. Lower P concentrations were caused by the treatments containing N-VIRO SOIL™ than by the control in the first leaching event, suggesting that N-VIRO SOIL™ has high P-retention capacity and can hold more P in the soil against leaching.

When cumulative P leached (percentage in total P added) was presented against leaching events, it was clear that most P leaching loss occurred in the first three leaching events, accounting for 62.0-98.8% of the total P leached during the whole leaching period, with 30.6-89.4% from the first leaching event (FIG. 2). Over the whole leaching period, the treatment with water-soluble P fertilizer resulted in the most P loss (96.6% of total P added), of which 98.8% occurred in the first three leaching events (FIG. 2a). In contrast, P losses from the treatments with the DPR/N-VIRO SOIL™ mixture were much less, only 0.3 to 3.8%, of which 62.0-68.7% occurred in the first three leaching events (Table 3, FIG. 2b). Among the treatments of DPR/N-VIRO SOIL™ mixtures, the 0% DPR/N-VIRO SOIL™ mixture fertilizer treatment caused the greatest P loss (3.8%), followed by the 10% DPR/N-VIRO SOIL™ mixture treatment (1.1%).

Phosphorus losses from all the other treatments were less than 1% (0.73%. 0.48%, 0.45%, 0.38%, 0.32%, respectively, for the 20%, 30%, 100%, 40% and 50% DPR/N-VIRO SOIL™ mixture treatments). These results indicate that the combination of N-VIRO SOIL™ with DPR was more effective than N-VIRO SOIL™ alone in reducing P leaching loss.

Elliott et al., supra (2002) found that leachate P from two acid soils amended with eight biosolids was mostly below 0.3% of applied P. In this study, slightly higher percentages of P added with N-VIRO SOIL™-based DPR fertilizers were leached. This could be mainly attributed to greater leaching volume and more leaching events in this study while P leaching was also related to some soil properties including clay content, organic matter, Al and Fe oxides, CaCO₃, and soil pH (Cogger and Duxbury, “Factors affecting phosphorus losses from cultivated organic soils,” Journal of Environmental Quality, 13:111-114 (1984); James et al., “Phosphorus mobility in calcareous soils under heavy manuring,” Journal of Environmental Quality, 25:770-775 (1996); Lookman et al., “Relationship between soil properties and phosphate saturation parameters, a transect study in northern Belgium,” Geoderma, 69:265-274 (1996); Turtola and Jaakkola, “Loss of phosphorus by surface runoff and leaching from a heavy clay soil under barley and grass ley in Finland,” Acta Agriculturae Scandinavica, Section B-Soil and Plant Science, 45(3):159-165 (1995)).

### Conclusions

There is a substantial impact of P leaching in sandy soils on the environment, especially on aquatic systems because P leached from sandy soils with low organic matter was dominantly in reactive form (67.7˜99.9%), which is readily available to algae. It is critical to control P leaching from the sandy soils where fresh water systems are sensitive to P input. The N-VIRO SOIL™-based DPR fertilizers were superior to water-soluble P fertilizer in reducing P leaching from sandy soil due to their slow release nature. On average, <1% of the total applied P was leached from the soils amended with the DPR/N-VIRO SOIL™ mixtures, whereas 96.6% was leached from the commercially available water-soluble P fertilizer.

Based on the results from this study, use of the DPR/N-VIRO SOIL™ mixtures appears to be better than water-soluble P fertilizer for the acidic sandy soils because they can provide adequate P for crop growth with minimal loss of P by leaching.

### EXAMPLE 2

### Materials and Methods

### Soil and Amendments

A typical acidic sandy soil (Wabasso sand 96.1%, silt 2.3%, and clay 1.6%) classified as hyperthermic alfic haplaquods, was sampled from the 0-40 cm layer in Fort Pierce, Fla. Wabasso sand is a representative agricultural soil of commercial citrus and vegetable production systems in this area. The collected soil was air-dried and passed through a 2.0 mm sieve. Selected properties of the soil were 5.0 g kg⁻¹ organic C, 0.23 g kg⁻¹ total N, 4.2 pH (1:1 H₂O), 3.2 pH (1:1 KCl), 5.1 mg NaOH extractable P kg⁻¹ soil, 2.6 mg Olsen-P kg⁻¹ soil, 27 kg g⁻¹ microbial biomass C, and 0.38 cmolₑ kg⁻¹ 1.0M NH₄OAc extractable (Ca⁺Mg).

The DPR and N-VIRO SOIL™ were collected from an operation phosphate mine in Central Florida and Florida N-Viro International Corporation, respectively. The DPR material was ground to <0.149 mm for chemical analysis and following studies. The pH, electrical conductivity (EC) and nutritional composition of the amendments are presented in Table 4.

TABLE 4
Chemical composition and other relevant properties of DPR material and
N-VIRO SOIL ™ to be used for developing DPR fertilizers.

| | pH | EC | Total C | Total N | Total P | Total Ca | Total Mg | Total K |
|---|---|---|---|---|---|---|---|---|
| Amendment | (H₂O) | (μS cm⁻¹) | (g kg⁻¹) | (g kg⁻¹) | (g kg⁻¹) | (g kg⁻¹) | (g kg⁻¹) | (g kg⁻¹) |
| DPR | 7.2 ± 0.1 | 472 ± 33 | 0 | 0 | 96.0 ± 1 | 248 ± 4 | 8.0 ± 0.8 | 0.84 ± 0.03 |
| N-VIRO SOIL ™ | 11.7 ± 0.1 | 2200 ± 82 | 88.2 ± 2.1 | 7.2 ± 0.1 | 4.9 ± 0.2 | 102 ± 2 | 1.9 ± 0.1 | 3.52 ± 0.07 |

### Greenhouse Pot and Incubation Experiments

Portions of soil each weighing 2.45 kg⁻¹ (oven-dry basis) was amended with 0.05 kg N-VIRO SOIL™ and /or DPR. The amendments of this study included 0.05 kg of N-VIRO SOIL™ alone, N-VIRO SOIL™ mixed with 10%, 20%, 30%, 40%, and 50% of DPR, and DPR alone. The superphosphate treatment (soil amendment with 200 mg P kg⁻¹ as NaH₂PO₄) and controls (without amendments) were also prepared. There were six pots for each treatment. Three pots were used for plant growth and the other three were used for a soil incubation study (under the same conditions but without plants).

The total weight of each soil amendment mixture was 2.50 kg⁻¹ (oven-dry basis). Nitrogen (200 mg N kg⁻¹) and potassium (200 mg K kg⁻¹) were added in forms of KNO₃ and NH₄NO₃. The mixture was placed in plastic pots (diameter 16.5 cm and height 15 cm). The moisture content of the mixtures was adjusted to 70% of water-holding capacity (WHC), and lost moisture was supplemented by addition of water every other day by weighing throughout the experiment and by estimating the weight of fresh plants.

After 7 days' soil incubation, 8 radish seeds were sown after they had been sterilized with 0.5% NaClO₂ and thoroughly rinsed with distilled water. One week after germination, four of the healthy seedlings were retained in each pot. The plants were grown in a growth chamber (day/night temperature, 28/20° C.; photoperiod, 14 h light; relative humidity of 60/70%). After 40 days of growth, plants were harvested, and the roots were washed several times to remove the adhering soil. The plant materials were oven-dried, weighed separately, and then were grounded to pass through 1.0 mm sieve. The concentrations of C and N in the plant material were measured using a CN Analyzer (Vario MAX CN Macro Elemental Analyzer, Elemental Analysensystem GmbH, Hanau, Germany). The concentrations of Ca, Mg and P in the plant materials were determined by Inductively Coupled Plasma Atomic Emission Spectrometer (ICP-AES, Ultima, J Y Horiba Inc. Edision, N.J.).

At the time of plant harvest, soil samples were collected from the pots without plant and analyzed for NaOH—P (He et al., “Kinetics of phosphate rock dissolution in an acidic soil amended with liming materials and cellulose,” Soil Sci. Soc. Am. J., 60:1589-1595 (1999); He et al., “Factors affecting phosphate rock dissolution in acid soil amended with liming materials and cellulose,” Soil Sci. Soc. Am. J., 60:1596-1601 (1999); Olsen and Sommers, “Phosphorus,” In Methods of soil analysis, ED. A L Page pp. 403-430. ASA and SSSA, Madison, Wis. (1982)), and water-extractable P. Soil pH was measured in water at a soil:solution ratio of 1:1 using a pH meter (Model 220, Denver Instrument, Denver, Colo.). Soil extractable Ca and Mg were extracted with 1.0 M NH₄OAc and determined using the ICP-AES. Soil available N (NH₄⁺—N and NO₃—N) was determined by shaking a 2.5 g (oven-dry basis) fresh soil in 25 ml 2M KCl for 1 h. Concentrations of NH₄⁺—N and NO₃—N in the filtrate were analyzed using a N/P Discrete Autoanalyzer (EasyChem, Systea Scientific LLC, Oak Brook, Ill.).

The CH₃Cl fumigation-K₂SO₄ extraction method (Vance et al., “An extraction method for measuring soil microbial biomass C,” Soil Biol. Biochem. 19:703-707 (1987)) was used to determine soil microbial biomass-C and biomass-N. The content of K₂SO₄-extracted C from the CHCl₃-treated and untreated soils was determined by an automated TOC Analyser (Shimazu, TOC-5000, Japan) and a K_{EC} of 0.45 was used to convert the measured flush of C to biomass-C. The total N in soil extracts was measured by Kjeldahl digestion-distillation procedure and microbial biomass N was calculated by a K_{EN} of 0.54 (Yao et al., “Microbial biomass and community structure in a sequence of soils with increasing fertility and changing land use,” Microbiol Ecol., 40:223-237 (2000)).

### Results

### Effects of DPR and N-VIRO SOIL™ on Soil Properties

The mean values of soil chemical properties and microbial biomass with different treatments in the end of the incubation study are shown in Table 5. Amendment of soil with DPR or N-VIRO SOIL™ markedly affected soil pH and EC. DPR amendment increased soil pH about 1.9 units. The increase in soil pH was greater if combined by mixture with N-VIRO SOIL™. Liming effect of N-VIRO SOIL™ was much higher than that of DPR. Similarly, EC had an increased trend with increasing proportions of N-VIRO SOIL™.

Concentrations of extractable Ca and Mg were very low in the control soil, and were significantly increased for soil treated with DPR or N-VIRO SOIL™. Extractable Ca increased by 5 fold in DPR amendment, and 24 fold when the soil was further amended with N-VIRO SOIL™. The highest extractable Mg concentrations were found in the single amendment of DPR. The DPR treatment contained 6 times more extractable Mg than the control soil. Soil NH₄⁺—N was greatly decreased in response to amendments of DPR, N-VIRO SOIL™ and their combined application. Moreover, there was a systematic increase in soil NO₃—N with the decrease in soil NH₄⁺—N.

Microbial biomass-C (C_{mic}) in the soils ranged from 27.2 to 59.9 μg g⁻¹ (Table 5). Application of N-VIRO SOIL™ significantly increased microbial biomass C. Soil C_{mic} was highly correlated with organic C and total N. Similar to C_{mic}, there was a marked increase in the microbial biomass N with increasing proportions of N-VIRO SOIL™ in the combined amendments.

The availability of P released from DPR dissolution and /or N-VIRO SOIL™ was also examined. NaOH-P in the control soil was very low (5.1 mg kg⁻¹) and increased to 172.4 mg kg⁻¹ in the soil treated with DPR, to 28.7 mg kg⁻¹ in the soil treated with N-VIRO SOIL™. A systematic decrease in the NaOH—P was found with increasing proportion of N-VIRO SOIL™ in the newly developed DPR based fertilizers. Water-extractable P and Olsen-P was much lower than NaOH—P, but showed similar tends as NaOH—P.

### Effects of DPR and N-VIRO SOIL™ on Plant Growth

Application of DPR, N-VIRO SOIL™ and superphosphate had great effects on the dry matter yield of radish (Table 6). All the P fertilizer treatments were superior to the control without P application. Some combined amendments of DPR and N-VIRO SOIL™ were more effective than DPR or N-VIRO SOIL™ alone in plant growth. The amendments containing 30% or 20% of DPR materials appeared to be the optimal, and maximum yield was achieved from the pot that received the newly developed fertilizer containing 20% DPR materials and 80% N-VIRO SOIL™.

Plant N concentrations were similar among the different treatments except the control and superphosphate treatment had higher plant N concentrations. The beneficial effects of DPR and N-VIRO SOIL™ on plant Ca and Mg contents were apparent (Table 6). Plant Ca and Mg concentrations increased by 2.3 and 3.9 fold in the DPR treatment, whereas plant Ca and Mg concentrations increased by 5.7 and 1.5 fold in the N-VIRO SOIL™ treatment. For the treatments of the two combined amendments, plant Ca concentration was significantly increased with increasing proportions of N-VIRO SOIL™, whereas plant Mg concentration was decreased with increasing proportions of DPR material.

Plant P concentration increased by DPR proportions in the combined amendments, although plant P concentration for the DPR treatment was lower than that for the superphosphate treatment. N-VIRO SOIL™ also increased plant P availability. Plant P concentration of the N-VIRO SOIL™ treatment was 5 times higher than that of the control. There were positive correlation between Olsen-P, NaOH—P, or water extractable-P, and plant P concentration (Table 7). The correlation between plant N concentration and Olsen-P was higher than that between plant N concentration and water extractable-P or NaOH—P.

TABLE 5
Effect of DPR and N-VIRO SOIL ™ amendments on soil chemical properties and microbial biomass in an incubation study.

| | | EC | NaOH | | Water | | | Extractable | Extractable | Microbial | Microbial |
|---|---|---|---|---|---|---|---|---|---|---|---|
| | pH | (μS | Extractable P | Olsen P | extractable P | NH₄⁺—N | NO₃⁻—N | Ca | Mg | biomass C | biomass N |
| Treatments | (H₂O) | cm⁻¹) | (μg g⁻¹) | (μg g⁻¹) | (μg g⁻¹) | (μg g⁻¹) | (μg g⁻¹) | (μg g⁻¹) | (μg g⁻¹) | (μg g⁻¹) | (μg g⁻¹) |
| 100% DPR | 6.1 | 637 | 172.4 | 35.9 | 12.6 | 24.3 | 145.8 | 296 | 69 | 34.6 | 6.5 |
| 50% DPR + 50% | 7.5 | 685 | 74.6 | 25.7 | 2.6 | 13.1 | 159.2 | 681 | 35 | 43.5 | 8.3 |
| N-VIRO SOIL ™ | | | | | | | | | | | |
| 40% DPR + 60% | 7.6 | 723 | 70.6 | 23.8 | 2.3 | 14.3 | 161.3 | 775 | 31 | 47.2 | 8.4 |
| N-VIRO SOIL ™ | | | | | | | | | | | |
| 30% DPR + 70% | 7.7 | 766 | 59.5 | 23.1 | 1.9 | 8.9 | 160.6 | 948 | 28 | 52.2 | 8.7 |
| N-VIRO SOIL ™ | | | | | | | | | | | |
| 20% DPR + 80% | 7.8 | 983 | 52.2 | 24.1 | 1.6 | 8.0 | 162.5 | 1087 | 24 | 56.4 | 9.2 |
| N-VIRO SOIL ™ | | | | | | | | | | | |
| 10% DPR + 90% | 7.8 | 1047 | 45.7 | 22.4 | 1.2 | 9.5 | 157.8 | 1271 | 21 | 59.9 | 10.2 |
| N-VIRO SOIL ™ | | | | | | | | | | | |
| 100% N-VIRO | 7.9 | 1138 | 28.7 | 20.4 | 1.2 | 10.3 | 158.1 | 1374 | 15 | 59.5 | 10.7 |
| SOIL ™ | | | | | | | | | | | |
| Superphosphate | 4.2 | 749 | 169.4 | 133.8 | 121.2 | 54.6 | 126.4 | 54 | 11 | 31.7 | 4.9 |
| Control | 4.2 | 721 | 5.1 | 2.6 | 0.6 | 53.2 | 124.3 | 57 | 11 | 27.2 | 5.0 |
| LSD_{0.05} | 0.1 | 30 | 4.8 | 1.7 | 0.4 | 1.3 | 3.9 | 31 | 3 | 4.1 | 0.9 |

TABLE 6
Dry matter yield and nutrient concentrations of radish in the greenhouse study

| | Dry matter yield | N | P | Ca | Mg |
|---|---|---|---|---|---|
| Treatments | (g pot⁻¹) | (%) | (mg g⁻¹) | (mg g⁻¹) | (mg g⁻¹) |
| 100% DPR | 1.79 | 4.7 | 10.1 | 13.4 | 7.0 |
| 50% DPR + 50% N-VIRO SOIL ™ | 1.50 | 4.6 | 6.5 | 23.8 | 4.5 |
| 40% DPR + 60% N-VIRO SOIL ™ | 1.41 | 4.7 | 6.1 | 25.6 | 3.9 |
| 30% DPR + 70% N-VIRO SOIL ™ | 2.10 | 4.5 | 5.3 | 29.4 | 3.6 |
| 20% DPR + 80% N-VIRO SOIL ™ | 2.16 | 4.5 | 5.0 | 29.1 | 3.5 |
| 10% DPR + 90% N-VIRO SOIL ™ | 1.69 | 4.6 | 4.9 | 31.7 | 2.8 |
| 100% N-VIRO SOIL ™ | 1.84 | 4.4 | 4.8 | 33.1 | 2.9 |
| Superphosphate | 1.04 | 6.2 | 27.2 | 4.2 | 1.6 |
| Control | 0.67 | 6.8 | 0.8 | 5.8 | 1.8 |
| LSD_{0.05} | 0.09 | 0.3 | 0.3 | 0.7 | 0.4 |

TABLE 7
Correlation coefficients (r) among soil properties and some plant parameters

| | | | NaOH | | Water | Extractable | Extractable | Microbial | Microbial |
|---|---|---|---|---|---|---|---|---|---|
| | | EC | extractable P | Olsen P | extractable P | Ca | Mg | biomass C | biomass N |
| Plant variables | pH | (μS/cm) | (mg/kg) | (mg/kg) | (mg/kg) | (mg/kg) | (mg/kg) | (mg/kg) | (mg/kg) |
| Dry matter yield | 0.811** | 0.418 | −0.012 | −0.261 | −0.399 | 0.739* | 0.371 | 0.767** | 0.737** |
| Plant P content | −0.501 | −0.246 | 0.810** | 0.994** | 0.970** | −0.475 | −0.055 | −0.393 | −0.494 |
| Plant Ca content | 0.974** | 0.648* | −0.478 | −0.514 | −0.619* | 0.976** | 0.004 | 0.966** | 0.983** |
| Plant Mg content | 0.334 | −0.375 | 0.433 | −0.258 | −0.366 | 0.021 | 0.982** | 0.001 | 0.115 |

*, **Significant at 0.05 and 0.01levels of confidence, respectively (n = 9)

### Discussion

Compared with water-soluble fertilizers, the DPR-based mixtures of the invention are more environmentally friendly since they slowly release nutrients to meet plant requirements while remaining less subject to leaching. Moreover, the DPR/N-VIRO SOIL™ mixtures have the function of neutralizing soil acidity and providing Ca, Mg and other micronutrients to meet the needs of crop growth. Although other organic materials can be mixed with DPR that can function to neutralize soil acidity, provide nutrients, and increase phosphorus availability, N-VIRO SOIL™ is an ideal candidate for mixture with DPR for application to acidic soils as it provides liming effects and certain amounts of organic matter, N, P, Ca and K.

In this study, the N-VIRO SOIL™ had higher effect on pH and electrical conductivity (EC) than the DPR. Incorporation of the N-VIRO SOIL™ increased liming capacity of the newly developed DPR/N-VIRO SOIL™ mixtures, which are more favorable to crop growth. Generally, the plant availability of P from the applied PR is mainly affected by soil properties such as pH and status of Ca and P (Hammond et al., “Agronomic value of unacidualated and partially acidulated phosphate rocks indigenous to the tropics,” Adv. Agron. 40:89-140 (1986); Wright et al., “Dissolution of North Carolina phosphate rock in soils of the Appalachian region,” Soil Sci. 153:25-36 (1992); Chien et al., “Factors affecting the agronomic effectiveness of phosphate rock for direct application,” Fert. Res. 41:227-234 (1995)).

Some studies suggested that the high organic matter in N-VIRO SOIL™ enhances the dissolution of PR by increasing the supply of H⁺ or by the continuous removal of the dissolved Ca and P from the dissolution zone (Kirk and Nye, “A simple model for predicting the rate of dissolution of sparingly soluble calcium phosphates in soil,” J. Soil Sci. 37:529-554 (1986)). However, in the present study, there were negative correlations between NaOH—P, Olsen-P, water extractable-P, or plant P content and N-VIRO SOIL™ proportions of the combined amendments. One reason of the reversed effect may be due to the difference in the quantity of DPR. Moreover, the tested soil had high sand/low organic matter content and minimal buffering capacity. The greater liming effect of N-VIRO SOIL™ raised soil pH quickly and consequently decreased the dissolution extent of DPR.

Soil microbial biomass plays a key role in maintaining soil fertility because its activity is the primary driving force for the biological cycles of almost all the major plant nutrients (Robert and Chenu, “Interactions between soil minerals and microorganisms,” pp. 307-393 in: Soil Biochemistry 7, Bollag, J. M., Stotzky, G. (eds.). Marcel Dekker, New York (1991); He et al., “Seasonal responses in microbial biomass carbon, phosphorus and sulphur in soils under pasture,” Biol Fertil Soils 24:421-428 (1997)). It is well established that a reasonably close, linear, and positive relationship exists between organic C and microbial biomass C contents in uncontaminated soils (Jenkison et al., “Microbial biomass in soil: measurement and turnover,” In Paul, E. A.; Ladd, J. N. Soil Biochemistry, New York: Marcel Dekker, v. 5, p. 415-471 (1981); Yao et al., 2003). As expected, soil microbial biomass C and N were significantly increased when the soil was amended with N-VIRO SOIL™, which had high organic matter content. Application of DPR also slightly increased soil microbial biomass, probably due to the marked increase in soil pH, which is more suitable for the growth and reproduction of soil microorganisms. Several investigators have reported that crop yield was highly correlated with microbial biomass through field experiment (Insam et al., “Relationship of soil microbial biomass and activity with fertilization practice and crop yield of three ultisols,” Soil Biol Biochem 23:459-464 (1991)). The results from this study indicate positive relationships between dry matter yield of radish and soil microbial biomass C and biomass N (Table 7).

Several extractants have been used to evaluate PR dissolution and P availability (Appthorp et al., “The effects of nitrogen fertilizer form on the plant availability of phosphate from soil, phosphate rock and monocalcium phosphate,” Fert. Res. 12:269-284 (1987); Bolan and Hedley, “Dissolution of phosphate rocks in soils. 1. Evaluation of extraction methods for the measurement of phosphate rock dissolution,” Fert. Res. 19:65-75 (1989)). The use of 0.5M NaOH as an extractant for PR dissolution was found to be better than 0.5M NaHCO₃, 1M NH₄OAc and water because the sorbed P from PR can be mostly extracted into 0.5M NaOH, but only a fraction can be extracted by other extractants (Sanyal and Datta, “Chemistry of phosphorous transformations in soil,” Adv. Soil Sci. 16:1-94 (1991)). The results of this study indicate that NaOH—P significantly increased by DPR proportions of the combined amendments, and NaOH—P were higher than 0.5M Olsen-P or water-extractable P. Olsen-P and water-extractable P in all the treatments did not have large differences except for those in the DPR treatment. However, Olsen-P appeared to be the best indicator for evaluating plant P availability since the relationship between plant P concentration and Olsen-P is better than that between plant P concentration and water extractable-P or NaOH—P.

Nitrate (NO₃—N) pollution of water via leaching and run off has been a primary focus of environmental research efforts when biosolids are applied to sandy soils (He et el, “Nitrogen mineralization and transformation from composts and biosolids during field incubation in sandy soil,” Soil Sci 165:161-169 (2000)). This study indicates that both. DPR and N-VIRO SOIL™ increased soil NO₃—N during incubation. Moreover, the decrease in NH₄—N was generally accompanied by a corresponding increase in NO₃-N, indicates that some NH₄—N was nitrified into NO₃—N form. Comparatively higher nitrification rate were found in N-VIRO SOIL™ treatment than that in DPR treatment. Generally, soil microbes play a fundamental role in governing soil-N cycle process and the environmental fate of fertilizer N. Both soil nitrifiers and heterotrophic microbes can exert some control on soil NO₃—N concentration by nitrification and assimilation, respectively. It is widely accepted that optimal pH range of nitrifer is 7.0 to 8.0, and soil NH₄—N assimilation is determined by the biomass and activity of soil microorganisms (Shi and Norton, “Microbial control of nitrate concentrations in an agricultural soil treated with dairy waste compost or ammonium fertilizer,” Soil Biology and Biochemistry 32:1453-1457 (2000)). Therefore, the possible reason of different mineral N concentrations may be due to the difference in soil pH and microbial community.

DPR material and N-VIRO SOIL™ are ideal liming amendments for acidic soils. Adequate combinations of the two amendments can supply more complete nutrients, reduce odors of the N-VIRO SOIL™ products and overcome dust problem of DPR powder. An important purpose of this study is to determine which combination has best agronomic effectiveness. Based on dry matter yield and plant P uptake, the combinations containing 30% and 20% of DPR material appeared to be advantageous. Soil extractable Ca and plant Ca concentration significantly increased with increasing proportions of N-VIRO SOIL™, whereas soil extractable P, extractable Mg and plant P, Mg concentrations significantly increased with increasing proportions of DPR material. Consequently, in addition to positive interactive effects on raised soil pH to a suitable level, the best agronomic potential of the combination containing 30% or 20% of DPR material is likely to maintain a good balance between available P, Ca and Mg for plant growth.

### EXAMPLE 3

The major objective of this study was to investigate the leaching potential of heavy metal from sandy soil amended with DPR/N-VIRO SOIL™ mixtures. The results were expected to provide helpful information for application of the DPR/N-VIRO SOIL™ mixtures of the invention in field.

### Materials and Methods

### Soil and N-VIRO SOIL™-Based DPR Fertilizers

A typical acidic sandy soil (Wabasso sand 96.1%, silt 2.3%, and clay 1.6%) classified as hyperthermic Alfic Haplaquods, was collected at the 0-30 cm depth in Fort Pierce, Fla. Selected properties of the soil were showed in Table 8. The pH was measured in water at the soil:water ratio of 1:2 (w/w) using a pH/ion/conductivity meter (Accumet Model 50, Fisher Scientific Inc. Atlanta, Ga.). Total organic C were determined by combustion using a CN analyzer (Vario Max CN, Macro Elemental Analyzer System GmbH, Hanau, Germany). Particle size distribution was determined by the pipette method (Andreasen, AHT, “The fineness of solids and the technological importance of fineness,” IngeniØrvidenskabelige Skrifter, 3:1-71 (1939)). Cation exchange capacity (CEC) was determined by extraction with 1 mol/L NH₄NO₃ (Stuanes A O et al., “Ammonium nitrate as extractant for soil exchangeable cations, exchangeable acidity and aluminium,” Commun Soil Sci Plant Anal, 15:773-778 (1984)). Total contents of Cd, Ni, Pb, Cu and Zn were determined using an Inductively Coupled Plasma Atomic Emission Spectrometry (ICPAES, Ultima, JY Horiba Inc., Edison, N.J., USA) following digestion with aqua regia and hydrofluoric acid (Hossner L R, “Dissolution for total elemental analysis,” in Methods of Soil Analysis. Part 3. Chemical Methods, Soil Science Society of America and American Society of Agronomy, 677 S. Segoe Rd., Madison, Wis. 53711, USA., SSSA Book Series No. 5, pp. 49-64 (1996)).

TABLE 8
Selected physical and chemical characteristics of the soil

| Parameters | Soil |
|---|---|
| Sand (g/100 g) | 96.1 |
| Silt (g/100 g) | 2.3 |
| Clay (g/100 g) | 1.6 |
| Texture | sand |
| pH (H₂O) | 4.1 |
| CEC (cmol/kg) | 0.4 |
| Total organic C (g/kg) | 5.0 |
| Total Cu (mg/kg) | 1.78 |
| Total Zn (mg/kg) | 9.74 |
| Total Pb (mg/kg) | 1.72 |
| Total Cd (mg/kg) | 0.02 |
| Total Ni (mg/kg) | 0.46 |

TABLE 9
Nutritional composition and relevant properties of N-VIRO SOIL ™ based DPR fertilizers.

| | | | | | | | Total | Total | Total | Total | Total | Total | Total |
|---|---|---|---|---|---|---|---|---|---|---|---|---|---|
| | pH | EC | Total C | Total N | Total P | Total K | Mg | Ca | Cu | Zn | Pb | Cd | Ni |
| DPR % | (H₂O) | (μS/cm) | g/kg | g/kg | g/kg | g/kg | g/kg | g/kg | mg/kg | mg/kg | mg/kg | mg/kg | mg/kg |
| 0 | 11.7 | 2200 | 88.2 | 7.24 | 4.93 | 3.53 | 1.96 | 292.9 | 211.8 | 163.9 | 15.4 | 1.81 | 33.7 |
| 10 | 11.5 | 1850 | 79.4 | 6.52 | 15.7 | 3.25 | 2.56 | 320.1 | 192.7 | 152.0 | 14.6 | 1.84 | 31.9 |
| 20 | 11 | 1830 | 70.6 | 5.79 | 26.4 | 2.97 | 3.16 | 347.8 | 173.7 | 140.2 | 13.8 | 1.87 | 30.1 |
| 30 | 10.7 | 1780 | 61.8 | 5.07 | 37.2 | 2.69 | 3.77 | 375.2 | 154.6 | 128.3 | 12.9 | 1.90 | 28.2 |
| 40 | 10.5 | 1600 | 52.9 | 4.34 | 47.9 | 2.41 | 4.37 | 402.7 | 135.6 | 116.4 | 12.1 | 1.93 | 26.4 |
| 50 | | 1500 | 44.1 | 3.62 | 58.7 | 2.14 | 4.97 | 430.1 | 116.5 | 104.6 | 11.3 | 1.96 | 24.6 |
| 100 | 7.2 | 452 | 0.00 | 0.00 | 112.4 | 0.74 | 7.98 | 567.3 | 21.2 | 45.2 | 7.17 | 2.11 | 15.5 |

The DPR source selected for this study was from IMC Four Comers in Central Florida because of its relatively high concentrations and availability of P and other nutrients such as Ca and Mg than other DPR sources. The N-VIRO SOIL™ samples were provided by the Florida N-Viro, L. P. Company. It was developed from biosolids and fly ash (1:1) and has been increasingly used in citrus groves, gardens, and vegetable fields in Florida and other states in the USA. The DPR was ground to <100 mesh and then mixed with N-VIRO SOIL™ at the proportions of 0, 10, 20, 30, 40, 50, and 100% DPR. Some chemical properties and nutritional values of these DPR/N-VIRO SOIL™ mixtures are presented in Table 9.

Total C and N in the DPR/N-VIRO SOIL™ mixtures were determined by combustion using a CN analyzer (Vario Max CN, Macro Elemental Analyzer System GmbH, Hanau, Germany). The pH was measured in water at the solid:water ratio of 1:2 (w/w) using a pH/ion/conductivity meter (Accumet Model 50, Fisher Scientific Inc. Atlanta, Ga.). Electrical conductivity (EC) was measured in solution at a solid:water ratio of 1:2 using a pH/ion/conductivity meter (Accumet Model 50, Fisher Scientific Inc. Atlanta, Ga., USA). Total contents of P, K, Ca, Mg, Cd, Ni, Pb, Cu and Zn in the DPR fertilizers were determined using an Inductively Coupled Plasma Atomic Emission Spectrometry (ICPAES, Ultima, JY Horiba Inc., Edison, N.J., USA) following digestion with aqua regia and hydrofluoric acid.

### Column Leaching Experiment

A column leaching study was conducted using 27 plastic columns (6.6 cm inner diameter and 30.5 cm long) with leaching solution delivered by a peristaltic pump (PumpPro MPL, Watson-Marlow, Inc., Wilmington Mass., UK). There are a fitted netting and a column holder with little pore under each column for leachate to pass through and to prevent soil loss. A plastic bottle was prepared to collect leachate filtered with a filter paper.

Soil (1 kg oven-dried) was amended with different DPR/N-VIRO SOIL™ mixtures, pure DPR or N-VIRO SOIL™, and then packed into the column. The treatments included: (1) control without any fertilizer, (2) the DPR/N-VIRO SOIL™ mixtures with combination of DPR with N-VIRO SOIL™ at rates of 0, 10, 20, 30, 40, 50, and 100%, respectively. The DPR/N-VIRO SOIL™ mixtures were added to soil at 1% (w/w). Each treatment was replicated three times. Soil columns were leached with deionized water. Leaching was conducted once per week for ten times. For each leaching, 118.3 mm of deionized water was used with the total leaching volume equivalent to the average annual rainfall (1183 mm) in the last three years (2001˜2003). Leachate samples from each leaching event for all treatments were collected and analyzed for heavy metal. Heavy metals were determined by an Inductively Coupled Plasma Atomic Emission Spectrometry (ICPAES, Ultima, JY Horiba Inc., Edison, N.J., USA)

### Results and Discussion

### Soil and Different DPR Fertilizers Characteristics

Wabasso soil, which is a representative agricultural soil of commercial citrus and vegetable production systems in the Indian River area in Fort Pierce, Fla., has coarse texture (96.1% sand), low contents of clay and organic matter, low pH and low CEC (Table 8). Total heavy metals (Cu, Zn, Pb, Cd and Ni) in the soil are apparently lower compared with those reported in other soils. This can be mainly explained by low pH which can enhance the solubility of heavy metals in the soil and thus readily cause heavy metal losses by the uptake of plants, surface runoff or ground water migration to the depth. Low contents of clay and organic matter, which can absorb heavy metals, also contribute to low levels of heavy metal.

The N-VIRO SOIL™, i.e. 0% DPR fertilizer, characterized as high organic matter content (88.2 g C/kg), high pH (11.7) and high electrical conductivity (EC, 2200 us/cm), has relatively high contents of Cu and Zn (211.8 and 163.9 mg/kg, respectively), a moderate content of Ni (33.7 mg/kg) and very low contents of Pb and Cd (15.4 and 1.81 mg/kg, respectively). The DPR, characterized as high contents of phosphorus and calcium (112.4 g P/kg and 567.3 g Ca/kg), has lower pH (7.2), greatly lower contents of Cu, Zn and Ni (21.2, 45.2 and 15.5 mg/kg, respectively), and slightly higher contents of Pb and Cd (7.17 and 2.11 mg/kg, respectively). Consequently, total heavy metals in the other DPR/N-VIRO SOIL™ mixtures with different proportions of DPR range between those in the DPR and N-VIRO SOIL™.

### Heavy Metal Concentration in Leachate

The concentrations of Cd, Pb and Ni in leachate from the control and the treatments of different DPR/N-VIRO SOIL™ mixtures were in general low for each leaching event, and most of them were below the detection limits. The maximum concentrations for Cd, Ni and Pb in leachate were only 2.7, 5.1 and 3.8 μg/L, respectively, and were far below drinking water quality guidance limits ruled by Florida Department of Environmental Protection (FDEP) (5, 100 and 15 μg/L, respectively) and World Health Organization (WHO) (4.5, 50 and 10 μg/L, respectively). There were no substantial differences observed between the control and the treatments of different DPR/N-VIRO SOIL™ mixtures or among leaching events. These results suggest that the soil amended with different DPR/N-VIRO SOIL™ mixtures at the given ratio in this study will not lead to the pollution of Cd, Ni and Pb by leaching for water quality.

Lower leachate concentrations of Cd, Ni and Pb were mainly attributed to very low levels of Cd, Ni and Pb in the soil and a small proportion of different DPR/N-VIRO SOIL™ mixtures (1%) added to the soil while they have relatively high concentrations of Cd, Ni and Pb. Gove et al. (2001) reported that sand and sandy loam amended with biosolids caused Ni and Pb concentrations beyond FDEP and WHO drinking water limits (“Movement of water and heavy metals (Zn, Cu, Pb, Ni) through sand and sandy loam amended with biosolids under steady state hydrological conditions,” Bioresource Tech, 78(2):171-179). This is mainly related with higher concentrations of Ni and Pb, different biosolids used and different ratios of biosolids amended to soils compared with our study. Soil characteristics such as organic matter content and soil pH also contributed to the different results, especially for Ni. For example, Ashworth and Alloway (2004) found that the change of leachate Ni concentration was similar to that of dissolved organic matter (DOM) in leachate and thus thought that DOM was significant in the mobility and solubility of Ni (“Soil mobility of sewage sludge-derived dissolved organic matter copper, nickel, and zinc,” Environmental Pollution, 127:137-144).

Compared with Cd, Ni and Pb, there were higher leachate concentrations of Cu and Zn for each leaching event during the whole study period (ranging from 0.7 to 37.1 μg/L for Cu and 5.1 to 205.6 μg/L for Zn). However, the maximum concentrations of Cu and Zn were also far below FDEP (1000 and 5000 μg/L, respectively) and WHO (1000 and 3000 μg/L, respectively) for drinking water quality guidance limits, suggesting that leaching from the soil amended with different DPR!N-VIRO SOIL™ mixtures is unlikely to cause the contamination of Cu and Zn to water system.

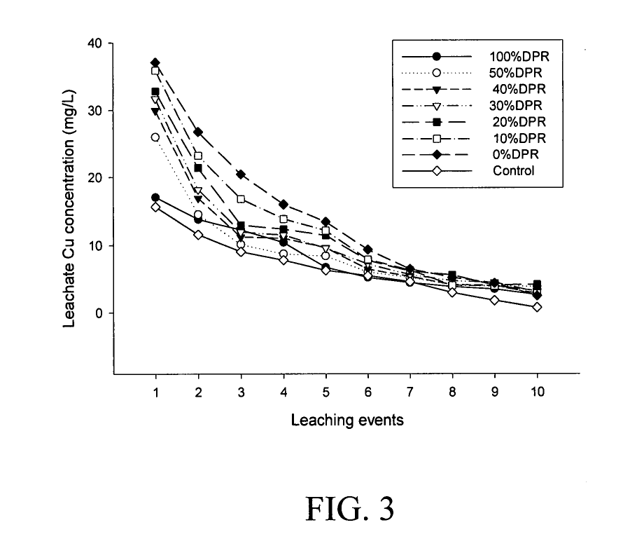

The changes of leachate Cu concentration vs. leaching events for the control and the treatments of different DPR-based fertilizers were shown in FIG. 3. There were similar trends of changes in Cu concentration for each treatment, that is, leachate Cu concentration decreased with increasing leaching events. However, it could be observed that the treatments with the DPR/N-VIRO SOIL™ mixture containing N-VIRO SOIL™ resulted in higher Cu concentrations than the control, especially in the first two leaching events, and that leachate Cu concentration increased with increasing proportion of N-VIRO SOIL™ in the DPR-based fertilizers. This was mainly because N-VIRO SOIL™ added to soil contained relatively high concentration of Cu.

With increasing leaching events, the leachate Cu concentrations for the treatments were closer to that for the control, suggesting that water-leachable Cu in N-VIRO SOIL™ was being depleted. After five leaching events, there were no significant differences between the control and the treatments with N-VIRO SOIL™. This phenomenon was consistent with the results reported by Sukreeyapongse et al. (2002) who studied the movement of Cu in one sandy soil amended with biosolids (“pH-dependent release of cadmium, copper, and lead from natural and sludge-amended soils,” Journal of Environmental Quality, 31:1901-1909). This study also found that the concentrations of Cu in leachates from the treatment with 100% DPR were very close to those from the control. This was because the amendment of DPR containing lower content of Cu compared with N-VIRO SOIL™ made no substantial change in Cu content in the soil.

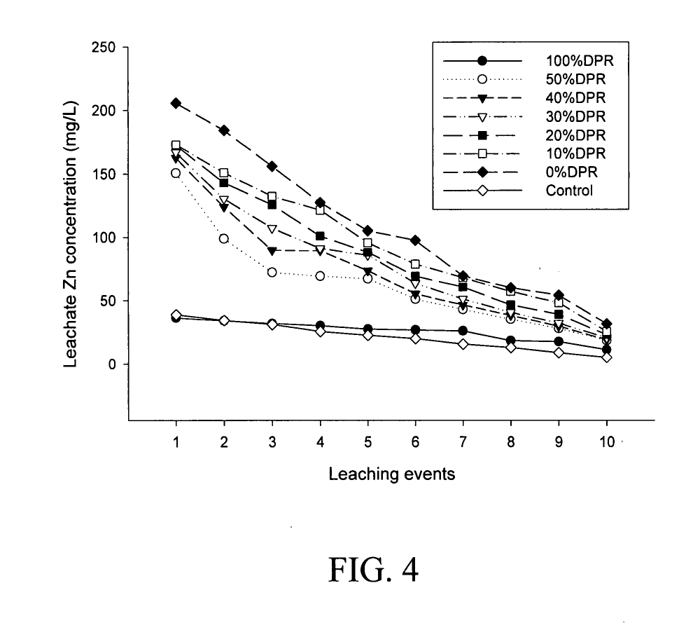

The changes of leachate Zn concentration versus. leaching events for the control and the treatments of different DPR/N-VIRO SOIL™ mixtures were shown in FIG. 4. In general, the changes of Zn concentrations showed similar trends to, those of Cu concentrations. However, there were some evident differences between the concentrations of Zn and Cu. First of all, higher concentrations were resulted in for Zn than for Cu. For example, with the first leaching event an example, the concentrations of Zn were 2.1-5.8 times higher than those of Cu.

There were greater differences between the control and the treatments with N-VIRO SOIL™ for Zn concentrations than for Cu concentrations, especially in the first several leaching events. For example, the treatments with N-VIRO SOIL™ resulted in 3.9-5.3 times higher than the control in Zn concentration for the first leaching event, but only 1.7-2.4 times higher than the control in Cu concentration. Of course, these results could be explained by higher content of Zn than Cu in the soils. However, more importantly, Zn is more relatively mobile due to lower stability constant for organo-Zn complexes than for organo-Cu complexes since soil clay plays a negligible role in heavy metal mobility due to its very low content in the soil tested in our study. The mobility of Zn was also well supported by Gove et al., “Movement of water and heavy metals (Zn, Cu, Pb, Ni) through sand and sandy loam amended with biosolids under steady state hydrological conditions,” Bioresource Technology 78(2): 171-179 (2001); Richards et al., “Effect of sludge processing mode, soil texture and soil pH on metal mobility in undisturbed soil columns under accelerated leaching,” Environmental Pollution 109:327-346 (2000); and Smith et al., “Irrigation of soil with synthetic landfill leachate-speciation and distribution of selected pollutants,” Environmental Pollution 106:429-441 (1999).

### Total Heavy Metal Losses

The analysis for total heavy metal losses after ten leaching events could directly reflect leaching strength of heavy metal. The total losses of Cd, Ni and Pb were not analyzed since most of their concentrations in leachate were below the detection limits.

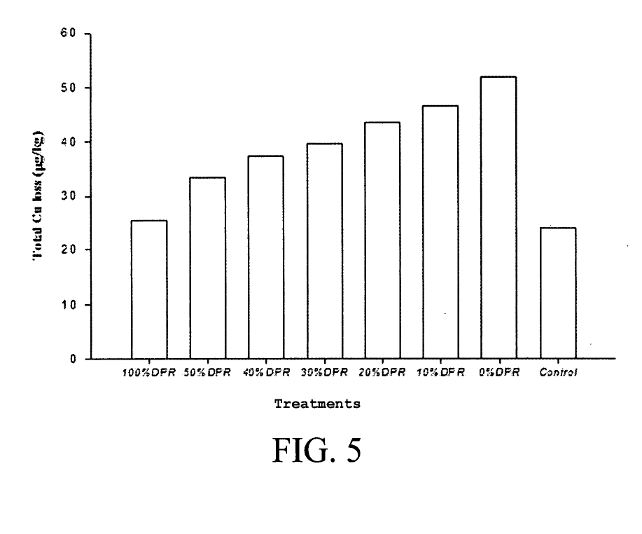

The total losses of Cu for each treatment after ten leaching events were shown in FIG. 5. There was no significant difference between the control and the treatment with 100% DPR. The total losses of Cu for the treatments with the DPR-based fertilizers containing N-VIRO SOIL™ were higher than those for the control and increased with increasing proportion of N-VIRO SOIL™ in the DPR-based fertilizers. This result indicates that the leaching of Cu was enhanced with the amendment of N-VIRO SOIL™. The total losses of Cu for the treatment with 0% DPR, i.e. pure N-VIRO SOIL™, doubled compared with the control.

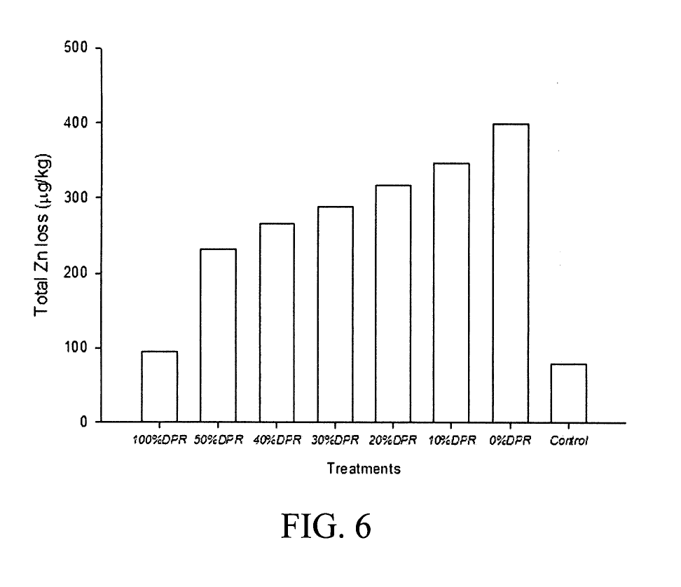

The total loss of Zn was similar to those of Cu (FIG. 6). However, greater differences in total losses of Zn were presented between the control and the treatments containing N-VIRO SOIL™ (3.0-5.1 times higher than the control for Zn and 1.4-2.2 times higher for Cu), suggesting that greater proportion of Zn losses come from the amendment of N-VIRO SOIL™ compared with Cu losses.

### Conclusions

Maximum leachate concentrations of Cd, Ni, Pb, Cu and Zn from the soil amended with different DPR/N-VIRO SOIL™ mixtures were far below FDEP and WHO drinking water quality guidance limits. Moreover, most of leachate concentrations for Cd, Ni and Pb were below the detection limits. By contrast, there were higher leachate concentrations of Cu and Zn due to their higher contents in both the soil and different DPR fertilizers compared with Cd, Ni and Pb. The differences in leachate concentrations of Cu and Zn between the control and the treatments with different DPR/N-VIRO SOIL™ mixtures containing N-VIRO SOIL™ were significant, especially in the first several leaching events and, moreover, increased with increasing proportion of N-VIRO SOIL™ in the DPR-based fertilizers. There were similar trends in total losses of Cu and Zn. Greater differences in both leachate concentrations and total losses of Zn between the control and the treatments containing N-VIRO SOIL™ were presented, suggesting that greater proportions of Zn losses came from the DPR fertilizers due to the greater mobility of Zn compared with Cu. In conclusion, the soil amended with different DPR fertilizers is unlikely to pose a major threat to water quality by leaching if the given ratio of DPR-based fertilizers here was applied.

### EXAMPLE 4

### Establishment of Field Sites

Four representative commercial farms (two citrus groves and two vegetable farms) were selected for this test in the Indian River area. Tensiometers were installed 15 cm and 30 cm depths, respectively, under the citrus trees to monitor soil moisture conditions. The tensiometers are read using a portable tensiometer. A reading number above −10 kPa indicates an adequate supply of soil water, whereas lower than −20 kPa reflects drought conditions.

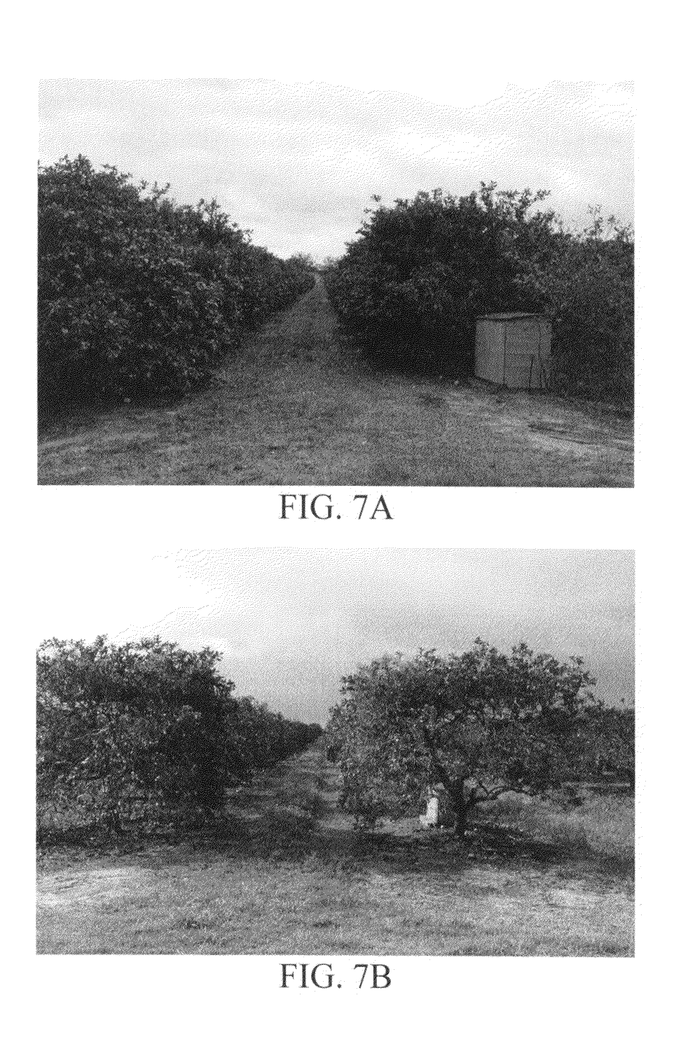

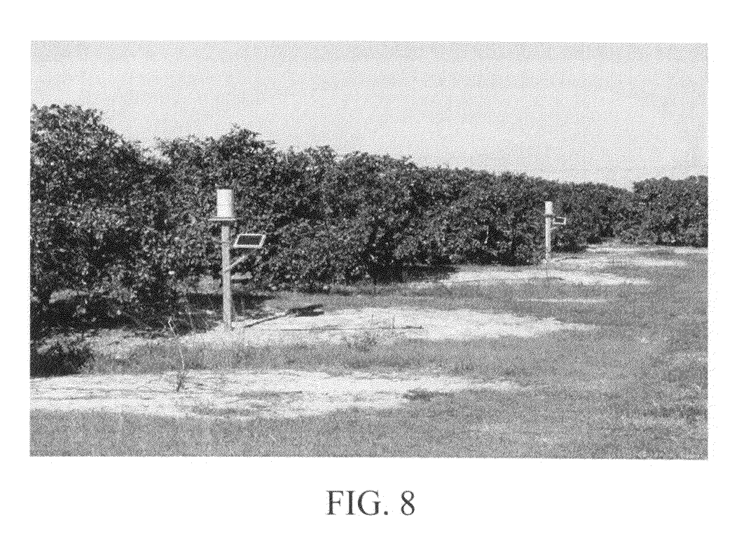

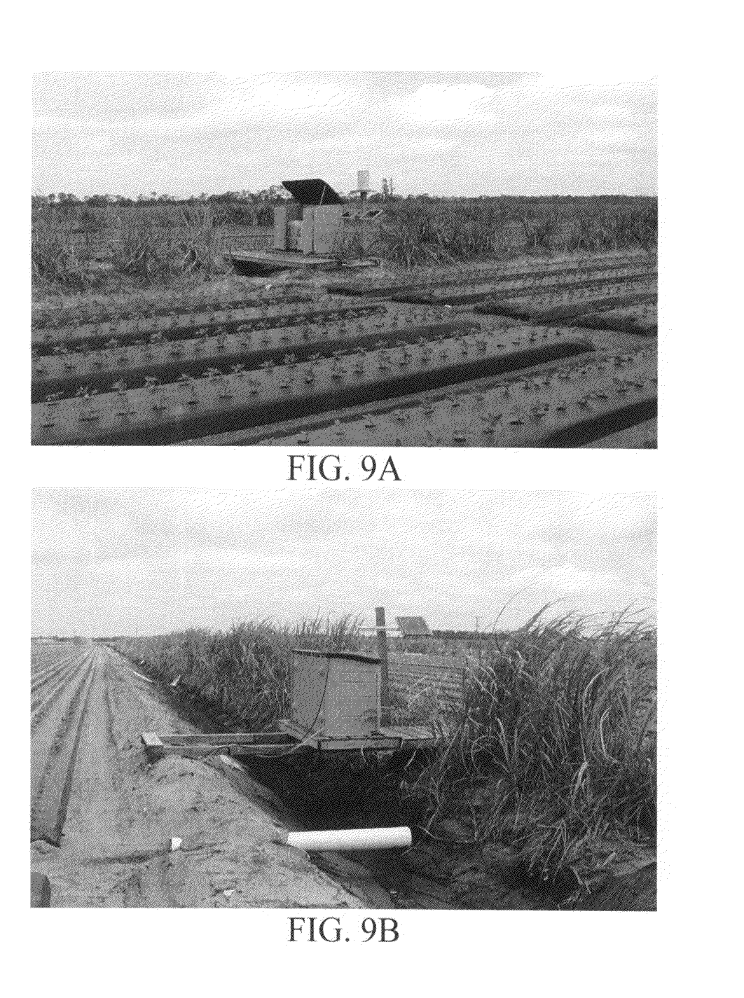

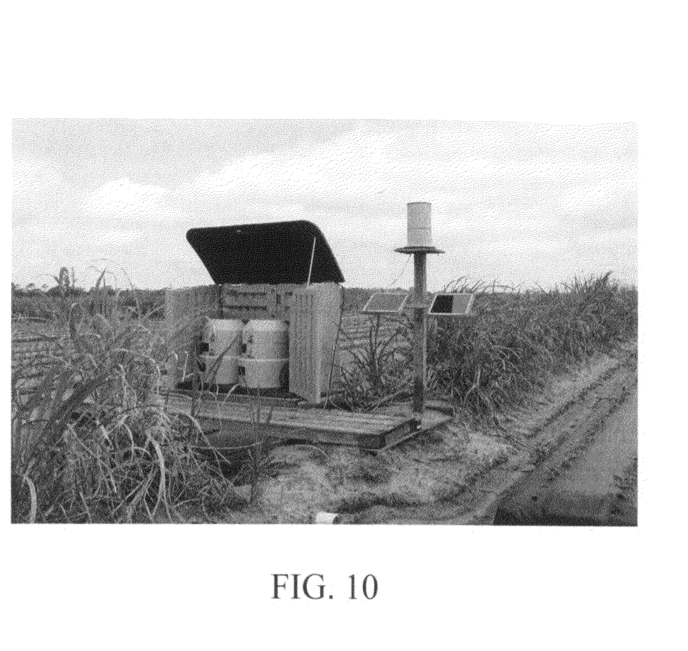

The autosamplers (SIGMA 900MAX portable sampler) were purchased and installed in the four field locations (FIGS. 7 to 10). These autosamplers have been programmed so that all the surface runoff samples can be divided into the first flush samples and the remaining composite samples. The first flush samples, defined as the samples collected in the first two hours, were collected into three bottles, each for 40 minutes in sequence. During the first 40 minutes the sampler collected three samples (one sample every 13 minutes and 20 seconds) and placed them into bottle No. 1, Bottle No. 2 and 3 samples were collected in a similar manner during the 2^{nd} and 3^{rd} 40-minutes periods, respectively.

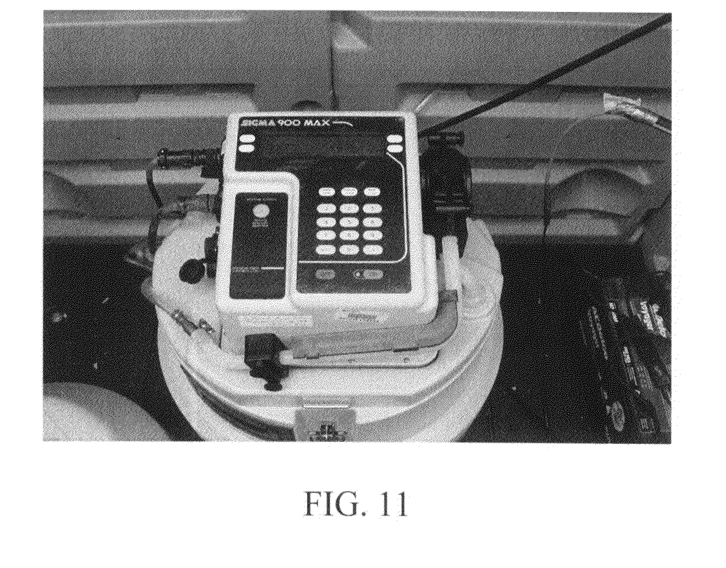

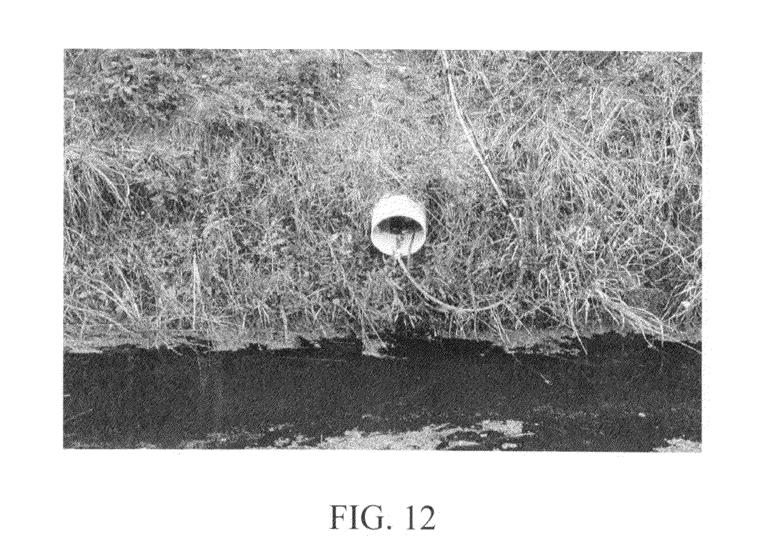

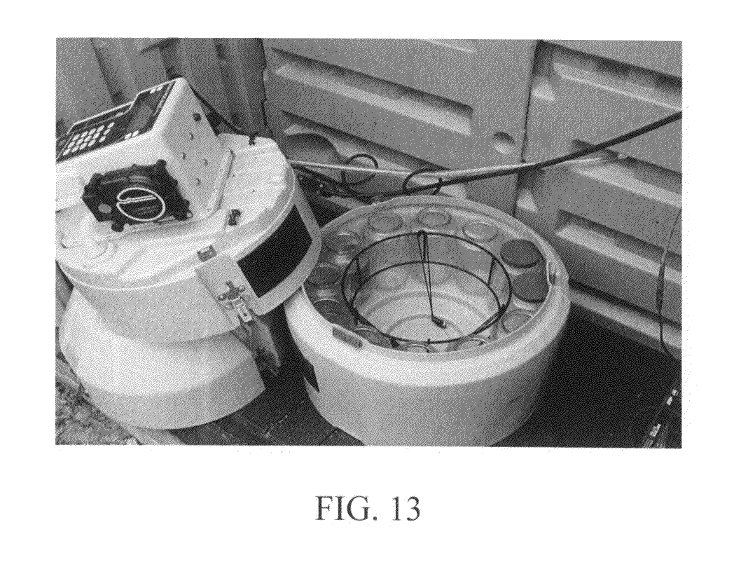

The composite samples were collected into another three bottles, each for 8 hours in sequence. During the first 8 hours the sampler collected three samples (one sample every two hours and 40 minutes) and placed them into bottle No. 4. Bottle No. 5 and 6 samples were collected in a similar way during the 2^{nd} and 3^{rd} 8-hours periods, respectively. These three samples represented for the 8th, 16th and 24th hours events (six samples in 24 hours) (FIGS. 11 to 13). The autosamplers were checked daily to ensure proper performance and to collect surface runoff samples, if available. Water samples collected from the autosamplers will be immediately transported to the IRREC Soil and Water Laboratory and analyzed for the following properties: (a) total P, dissolved total P, and ortho-P; (b) total N, TKN—N, nitrate, and ammonium; (c) metals: Ca, Mg, K, Na, Cu, Zn, Cd, Pb, Ni, Cr, Al, Fe, and Mn; and (d) pH, EC, total suspended solids, and turbidity.

Total P, dissolved total P, PO₄—P, TKN, NO₃—N, total N, and suspended solid loads in runoff for each runoff event will be determined as a product of nutrient or solid concentration in each runoff sample and each runoff discharge per event:

Load (g/ha)=Concentration (mg/L)×Discharge (m³)×10⁴/Site area (m²)

### Manufacturing and Application of DPR Fertilizers

The ODPR materials (approximately 12 tons) were collected from the IMC Fort Corner facility. This selection was based on our evaluation of the ODPR materials from major operation facilities in the central Florida, with respect to their nutritional values.

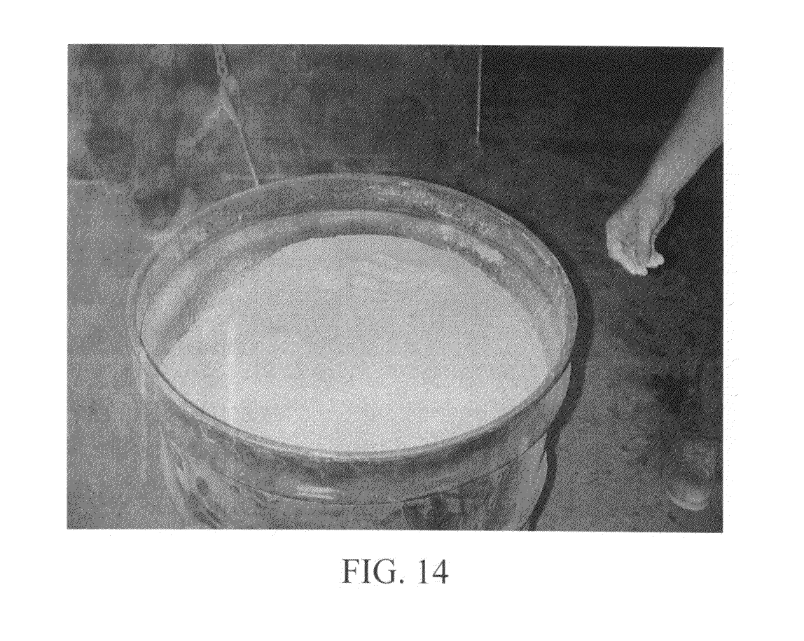

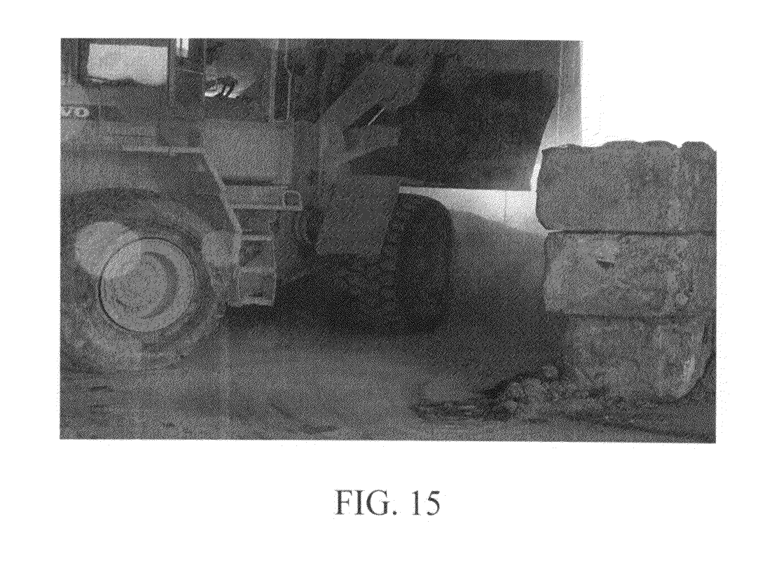

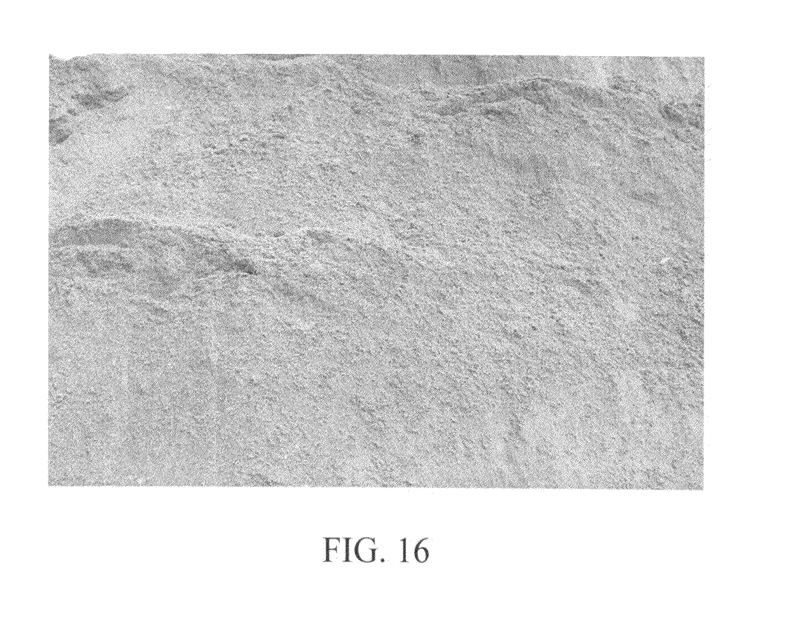

The materials were placed in 50 50-gallon open head drums and transported to the North Carolina State Engineering lab in Ashville, N.C. for drying and grinding. The ground ODPR materials (<100 mesh) were then delivered to Florida N-VIRO, L. P., (at 1990 Tomoka Farms road, Daytona Beach, Fla. 32124) for manufacturing the DPR fertilizers, where the ODPR materials were blended with biosolids based on the optimal formulas developed from the previous examples described herein with optimal moisture level for granulation (FIGS. 14 to 16).

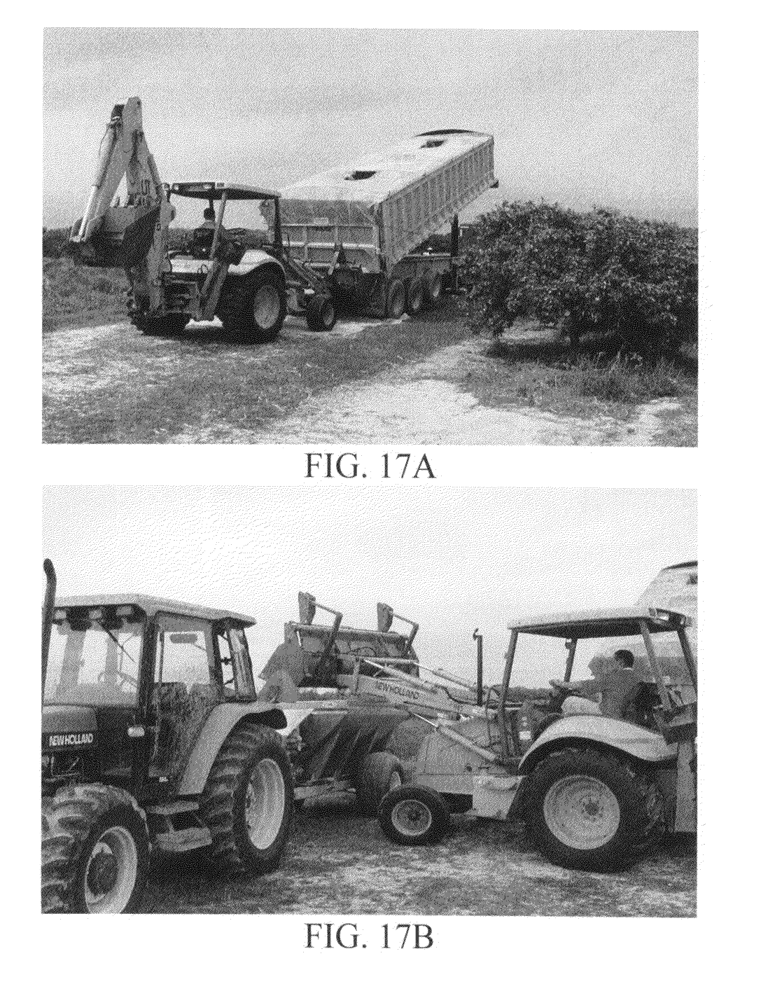

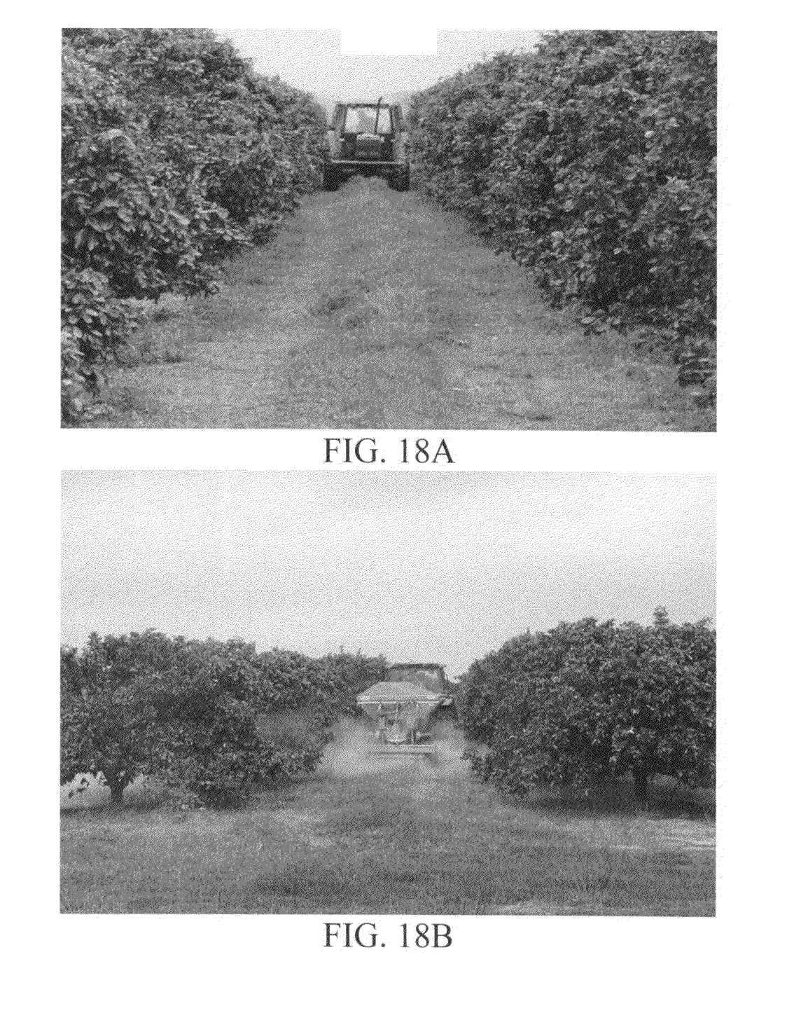

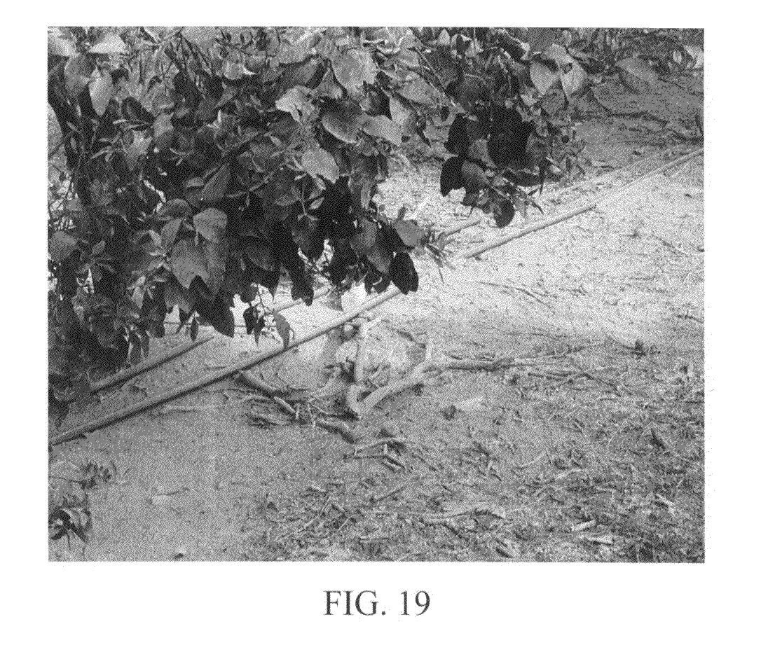

The manufactured DPR/N-VIRO SOIL™ mixtures of the invention were then transported to the citrus grove for application. The application was conducted using a mechanical spreader at the rate of 8000 kg /ha, which can provide sufficient P of slow release nature for citrus growth (FIGS. 17 to 19). As the field trials were used to mainly demonstrate the environmental quality benefits, only the optimal DPR/N-VIRO SOIL™ mixture with 30% ODPR materials and 70% N-VIRO SOIL™ (biosolids) was used in field trials to compare with complete water soluble fertilizers (Table 10). This DPR-based fertilizer contained approximately 31 g kg⁻¹ total P. All the nutrients except for P were applied at the same level for both DPR-based fertilizer and water soluble fertilizer treatments, with part of N, K in the DPR fertilizer being accounted for. The amount of available P in the applied DPR-based fertilizer is calculated based on 12% of the total P in the DPR-based fertilizers available for the crops in the first year, and 6% in the second year. The amount of P applied in the water soluble fertilizers was equal to that applied in the DPR-based fertilizer.

TABLE 10
Codes and basic information of the evaluation locations

| | | | Site | |
|---|---|---|---|---|
| | | | area | |
| Locations | Sites* | Codes | (m²) | Fertilization plan |
| #2(Vegetable) | DPR | 23 | 3686 | DPR fertilizer at 8000 kg/ha |
| | | | | plus N and K with total |
| | | | | amounts up to the grower's |
| | | | | rates |
| | CON | 21 | 3686 | N 291 P 90 kg/ha |
| #3(Citrus) | DPR | 33 | 5427 | DPR fertilizer at 8000 kg/ha |
| | | | | plus N and K with total |
| | | | | amounts up to the grower's |
| | | | | rates |
| | CON | 31 | 5427 | N 168 P 37 kg/ha |
| #4(Citrus) | DPR | 83 | 2511 | DPR fertilizer at 8000 kg/ha |
| | | | | plus N and K with total |
| | | | | amounts up to the grower's |
| | | | | rates |
| | CON | 81 | 2511 | N 168 P 37 kg/ha |
| #9(Vegetable) | DPR | 93 | 3240 | DPR fertilizer at 8000 kg/ha |
| | | | | plus N and K with total |
| | | | | amounts up to the grower's |
| | | | | rates |
| | CON | 91 | 3240 | N 291 P 90 kg/ha |

*OA: Organic amendment treatment;
CON: Grower's practices.

### EXAMPLE 5

### Soil Quality Characterization

Soil samples were collected before project implementation from 0-15 and 15-30 cm depths of each citrus or vegetable field location. The soils were air-dried, ground, and passed through a 2-mm sieve prior to physical and chemical analyses. These soil samples were analyzed for available nutrients and relevant chemical properties (Table 11). These data were used to evaluate the effects of DPR fertilizer on soil quality related to P leaching potential.

TABLE 11
Soil particle composition, pH, EC, available P and exchangeable N, in soils of the testing field locations

| | | | | | | | | | Available N | |
|---|---|---|---|---|---|---|---|---|---|---|
| | | Soil | Particle Composition | | | | | | (KCl—N) | Available P |
| | | depth | Sand | Silt | Clay | Organic C | pH | EC | NO₃—N + NH₄—N | (Olsen-P) |
| Field sites† | Soil classification | cm | g kg¹ | | | g kg⁻¹ | (H₂O) | μS cm⁻¹ | mg kg⁻¹ | |
| #2(Vegetable) | Sandy, siliceous, | 0–15 | 902 | 53.0 | 45.3 | 5.85 | 7.15 | 189 | 15.37 | 58.69 |
| | hyperthermic Alfic | 15–30 | 905 | 54.1 | 40.7 | 4.79 | 7.25 | 232 | 10.22 | 50.33 |
| | Alaquods | 30–60 | 906 | 51.0 | 42.9 | 3.76 | 6.80 | 231 | 7.78 | 21.75 |
| | | 60–90 | 911 | 33.7 | 55.1 | 7.30 | 5.85 | 248 | 5.01 | 14.50 |
| #3(Citrus) | Sandy, siliceous, | 0–15 | 908 | 42.8 | 49.6 | 9.06 | 7.40 | 423 | 6.03 | 15.77 |
| | hyperthermic, | 15–30 | 894 | 52.2 | 54.2 | 9.86 | 7.70 | 559 | 5.48 | 8.04 |
| | Arenic Glossaqualf | 30–60 | 913 | 14.2 | 73.2 | 2.65 | 7.90 | 349 | 3.02 | 4.58 |
| | | 60–90 | 945 | 17.5 | 37.0 | 0.98 | 7.75 | 301 | 3.54 | 1.60 |
| #4(Citrus) | Sandy, siliceous, | 0–15 | 945 | 13.4 | 41.2 | 9.06 | 6.55 | 800 | 8.40 | 24.50 |
| | hyperthermic, | 15–30 | 954 | 15.7 | 30.7 | 11.70 | 6.79 | 104 | 7.50 | 21.40 |
| | ortstein Arenic | 30–60 | 954 | 17.0 | 28.8 | 12.97 | 6.44 | 108 | 5.01 | 18.20 |
| | Alaquods | 60–90 | 892 | 61.4 | 46.9 | 10.28 | 7.19 | 180 | 3.98 | 18.80 |
| #9(Vegetable) | Sandy, siliceous, | 0–15 | 902 | 53.0 | 45.3 | 4.88 | 5.10 | 289 | 12.67 | 48.04 |
| | hyperthermic Alfic | 15–30 | 905 | 54.1 | 40.7 | 3.79 | 5.15 | 239 | 11.89 | 41.33 |
| | Alaquods | 30–60 | 906 | 51.0 | 42.9 | 1.99 | 5.15 | 251 | 7.05 | 21.75 |
| | | 60–90 | 911 | 33.7 | 55.1 | 2.70 | 5.20 | 268 | 6.89 | 14.50 |

### Water Quality Analysis

After the surface runoff water samples were collected from the autosamplers, they were processed and analyzed immediately. Prior to filtration, pH and EC of the water samples were determined using a pH/ion/conductivity meter following EPA 150.1 and EPA 120.1, respectively. Turbidity of water samples was measured using a Turbidity meter (DRT-100B, HF Scientific Inc., Fort Myers, Fla.). Solid concentrations of the water samples were measured using a gravimetry method with oven drying. Total P in the unfiltered surface runoff sample was determined by the molybdenum-blue method after digestion with acidified ammonium persulfate (EPA 365.1). Sub-samples were filtered through Whatman 42 filter paper.

Portions of the sub-samples were filtered further through a 0.45 μm membrane filter for measurement of total dissolved P and PO₄—P. The concentrations of anions including F, Cl, Br, NO₃—N, PO₄—P and SO₄—S were measured within 24 h after sample collection using an Ion Chromatograph (DX 500; Dionex Corporation Sunnyvale, Calif.) following EPA method 300. NH₄—N and Total Kjeldahl N (TKN) in the runoff sample were measured using a discrete autoanalyzer (EasyChem, Systea Scientific LLC, Oak Brook, Ill.) followed EPA method 351.3. Total N in the runoff sample was calculated as the sum of TKN and NO₃—N. Concentrations of total dissolved macro-elements in water were determined using the Inductively Coupled Plasma Atomic Emission Spectrometry (ICPAES, Ultima, JY Horiba Inc. Edison, N.J.) following EPA method 200.7.

Since the implementation of the field trials, 42 surface runoff water samples have been collected. The physical and chemical properties of the water samples were determined and reported in Table 12. The concentrations of anions including nitrate and phosphate are reported in Table 13.

TABLE 12
Electrical conductivity (EC), pH, turbidity, of surface
runoff water samples collected

| | Sampling | pH | EC (ms/cm) | Turbidity |
|---|---|---|---|---|
| Field ID | Time | (H2O) | ug/cm | (NTU) |
| 531001 | 11:17–11:44 | 7.24 | 825.6 | 9.6 |
| 531002 | 11:57–12:24 | 7.58 | 811 | 1.75 |
| 531003 | 12:37–13:04 | 7.57 | 803.9 | 1.49 |
| 531004 | 13:44–19:04 | 7.48 | 817.8 | 0.81 |
| 531005 | 21:44–03:04 | 7.28 | 517.8 | 3.67 |
| 531006 | 05:44–08:24 | 7.29 | 617.6 | 4.27 |
| 535001 | 16:41–22:01 | 7.56 | 99.37 | 1.86 |
| 535002 | 00:41–06:01 | 7.6 | 118.3 | 1.63 |
| 535003 | 09:17–11:57 | 8.1 | 581.9 | 3.7 |
| 535004 | 14:37–19:57 | 7.8 | 583 | 2.08 |
| 535005 | 22:37–03:57 | 8.03 | 519 | 2.13 |
| 535006 | 06:37–11:57 | 7.94 | 407 | 3.61 |
| 535007 | 14:37–19:57 | 7.67 | 244 | 3.04 |
| 535008 | 22:37–01:17 | 7.5 | 251.6 | 5.67 |
| 535009 | 10:20–10:47 | 7.63 | 738.9 | 4.11 |
| 535010 | 11:00–11:27 | 7.69 | 739.5 | 1.13 |
| 535011 | 11:40–12:07 | 7.62 | 738.6 | 1.12 |
| 535012 | 12:47–18:07 | 7.6 | 738.4 | 1.99 |
| 535013 | 20:47–02:07 | 7.28 | 549.9 | 3.45 |
| 535014 | 04:47–07:27 | 7.27 | 536.9 | 11.9 |
| 581001 | 20:35–21:01 | 6.96 | 396.2 | 27.2 |
| 581002 | 21:15–21:41 | 7.13 | 403.1 | 13.2 |
| 581003 | 21:58–22:21 | 7.31 | 416.5 | 5.3 |
| 581004 | 23:01–04:21 | 7.39 | 429.6 | 5.02 |
| 581005 | 07:01–12:21 | 7.41 | 497.6 | 4.73 |
| 585001 | 8:19 | 6.88 | 321.9 | 15.29 |
| 585002 | 08:33–08:59 | 7.24 | 329.5 | 1.81 |
| 585003 | 09:13–09:39 | 7.22 | 322.2 | 3.38 |
| 585004 | 10:19–15:39 | 7.29 | 330.4 | 3.8 |
| 585005 | 18:19–23:39 | 7.37 | 411.2 | 2.13 |
| 585006 | 02:19–07:39 | 7.31 | 460.9 | 2.18 |
| 585007 | 20:46–20:59 | 7.47 | 228.5 | 4.15 |
| 585008 | 21:13–21:39 | 7.67 | 214.1 | 2.37 |
| 585009 | 21:53–22:19 | 7.71 | 215.6 | 3.26 |
| 585010 | 22:59–04:19 | 7.76 | 254.6 | 1.9 |
| 585011 | 6:59 | 7.93 | 320.3 | 2.12 |
| 585012 | 23:10–23:34 | 7.62 | 468.4 | 2.79 |
| 585013 | 23:50–00:14 | 7.47 | 362.8 | 3.53 |
| 585014 | 00:30–00:56 | 7.45 | 350.2 | 3.91 |
| 585015 | 01:36–06:56 | 7.46 | 448.7 | 3.83 |
| 585016 | 09:36–14:56 | 7.45 | 488.2 | 4.42 |
| 585017 | 17:34–22:54 | 7.34 | 514.8 | 3.45 |

TABLE 13
Concentrations of anions in surface runoff samples collected

| | Sampling | F⁻ | Cl⁻ | Br⁻ | NO₃⁻—N | PO₄³⁻—P | SO₄²⁻—S |
|---|---|---|---|---|---|---|---|
| Field ID | Time | mg/L | | | | | |
| 531001 | 11:17–11:44 | 0.39 | 129.16 | 0.24 | 0.03 | 0.42 | 33.23 |
| 531002 | 11:57–12:24 | 0.40 | 128.55 | 0.42 | 0.27 | 0.27 | 32.82 |
| 531003 | 12:37–13:04 | 0.38 | 128.50 | 0.29 | 0.22 | 0.25 | 32.52 |
| 531004 | 13:44–19:04 | 0.39 | 131.49 | 0.24 | 0.30 | 0.26 | 32.63 |
| 531005 | 21:44–03:04 | 0.23 | 41.65 | 0.12 | 0.30 | 0.42 | 12.08 |
| 531006 | 05:44–08:24 | 0.24 | 55.11 | 0.18 | 0.16 | 0.43 | 16.73 |
| 535001 | 16:41–22:01 | 0.11 | 9.55 | 0.00 | 0.48 | 1.18 | 7.60 |
| 535002 | 00:41–06:01 | 0.10 | 12.67 | 0.00 | 0.15 | 0.88 | 11.09 |
| 535003 | 09:17–11:57 | 0.23 | 47.66 | 0.00 | 0.17 | 0.78 | 32.69 |
| 535004 | 14:37–19:57 | 0.18 | 42.67 | 0.00 | 0.27 | 0.98 | 29.88 |
| 535005 | 22:37–03:57 | 0.15 | 33.97 | 0.00 | 0.56 | 0.93 | 24.47 |
| 535006 | 06:37–11:57 | 0.14 | 20.47 | 0.00 | 0.90 | 1.02 | 15.52 |
| 535007 | 14:37–19:57 | 0.08 | 10.36 | 0.00 | 0.90 | 1.01 | 7.48 |
| 535008 | 22:37–01:17 | 0.09 | 8.42 | 0.00 | 0.78 | 0.77 | 6.39 |
| 535009 | 10:20–10:47 | 0.27 | 77.20 | 0.06 | 0.00 | 0.54 | 45.43 |
| 535010 | 11:00–11:27 | 0.28 | 75.12 | 0.21 | 0.00 | 0.58 | 45.52 |
| 535011 | 11:40–12:07 | 0.29 | 75.13 | 0.00 | 0.08 | 0.54 | 45.46 |
| 535012 | 12:47–18:07 | 0.31 | 77.26 | 0.22 | 0.00 | 0.51 | 44.79 |
| 535013 | 20:47–02:07 | 0.18 | 46.25 | 0.07 | 0.29 | 0.71 | 22.74 |
| 535014 | 04:47–07:27 | 0.17 | 38.82 | 0.00 | 0.06 | 0.86 | 18.38 |
| 581001 | 20:35–21:01 | 0.31 | 74.21 | 0.21 | 0.08 | 0.41 | 8.89 |
| 581002 | 21:15–21:41 | 0.36 | 72.52 | 0.15 | 0.05 | 0.59 | 8.95 |
| 581003 | 21:58–22:21 | 0.35 | 79.49 | 0.13 | 0.04 | 0.55 | 10.59 |
| 581004 | 23:01–04:21 | 0.36 | 76.11 | 0.18 | 0.00 | 0.45 | 10.52 |
| 581005 | 07:01–12:21 | 0.42 | 93.71 | 0.18 | 0.00 | 0.33 | 13.03 |
| 585001 | 8:19 | 0.38 | 260.07 | 0.18 | 0.15 | 0.68 | 40.09 |
| 585002 | 08:33–08:59 | 0.38 | 260.01 | 0.05 | 0.18 | 0.60 | 42.47 |
| 585003 | 09:13–09:39 | 0.40 | 267.39 | 0.16 | 0.12 | 0.61 | 43.85 |
| 585004 | 10:19–15:39 | 0.40 | 265.14 | 0.00 | 0.07 | 0.66 | 42.91 |
| 585005 | 18:19–23:39 | 0.48 | 345.96 | 0.28 | 0.04 | 0.40 | 52.77 |
| 585006 | 02:19–07:39 | 0.47 | 409.38 | 0.37 | 0.15 | 0.42 | 57.83 |
| 585007 | 20:46–20:59 | 0.38 | 159.71 | 0.19 | 0.08 | 0.44 | 18.88 |
| 585008 | 21:13–21:39 | 0.32 | 135.54 | 0.54 | 0.27 | 0.51 | 15.71 |
| 585009 | 21:53–22:19 | 0.39 | 136.46 | 0.16 | 0.23 | 0.48 | 16.00 |
| 585010 | 22:59–04:19 | 0.38 | 175.87 | 0.83 | 0.21 | 0.40 | 20.74 |
| 585011 | 6:59 | 0.39 | 227.87 | 0.28 | 0.10 | 0.35 | 27.58 |
| 585012 | 23:10–23:34 | 0.42 | 96.31 | 0.27 | 0.79 | 0.65 | 9.50 |
| 585013 | 23:50–00:14 | 0.33 | 59.39 | 0.11 | 1.67 | 0.77 | 6.02 |
| 585014 | 00:30–00:56 | 0.30 | 62.10 | 0.26 | 0.90 | 0.62 | 6.76 |
| 585015 | 01:36–06:56 | 0.36 | 106.98 | 0.00 | 0.24 | 0.51 | 11.24 |
| 585016 | 09:36–14:56 | 0.36 | 121.95 | 0.37 | 0.31 | 0.49 | 13.20 |
| 585017 | 17:34–22:54 | 0.36 | 134.69 | 0.14 | 0.38 | 0.52 | 15.06 |

### Conclusions

The application of DPR-based fertilizers made from DPR material and N-VIRO SOIL™ significantly improved dry matter yield of vegetable and citrus crops and plant P, Ca and Mg nutrition. Based on dry matter yield and plant N uptake, the combined amendments containing 30% DPR-based materials plus 70% N-VIRO SOIL™ appeared to be the optimal combination. In addition, DPR-based fertilizer application also tended to improve soil quality, including raised soil pH, improved balance of available nutrients, and increased soil microbial activity.

There is a substantial impact of P leaching in sandy soils on the environment, especially on aquatic system because P leached from sandy soils with low organic matter was dominantly in reactive form (67.7˜99.9%), which is readily available to algae. The N-VIRO SOIL™-based DPR fertilizers seem superior to water-soluble P fertilizer in reducing P leaching from sandy soil due to their slow release nature. On average, <1% of the total applied P was leached from the soils amended with the DPR fertilizers, whereas 96.6% was leached from the water-soluble fertilizer. Based on the results from this study, use of the DPR fertilizers appears to be better than water-soluble P fertilizer for the acidic sandy soils because they can provide adequate P for crop growth with minimal loss of P by leaching.

Maximum leachate concentrations of Cd, Ni, Pb, Cu and Zn from the soil amended with different DPR fertilizers were far below FDEP and WHO drinking water quality guidance limits. Moreover, most of leachate concentrations for Cd, Ni and Pb were below the detection limits. Therefore, application of DPR-based fertilizers is unlikely to pose a significant risk of heavy metal contamination to the surface or ground water at the given rates.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A method for increasing the availability of nutrients in soils while controlling the release of phosphorous, which comprises applying to a soil or a potting media soil a mixture comprising at least one waste from phosphate-related industries and at least one organic material.

2. The method according to claim 1, wherein the waste from phosphate-related industries is selected from the group consisting of: phosphate rock, dolomite phosphate rock, phosphatic clay, and phosphate fines.

3. The method according to claim 1, wherein about 20-50% of the mixture is composed of dolomite phosphate rock and about 50-80% of the mixture is the organic materials.

4. The method according to claim 1, wherein the organic material is selected from the group consisting of: livestock manure, poultry manure, sewage sludge, humic acid, fulvic acid, seaweed extracts, kelp extracts, municipal composts, and organic composts.

5. The method according to claim 1, wherein the mixture further comprises any one or combination of the ingredients selected from the group consisting of: companion cations, cation reducing agents, pH modulating compounds, plant nutrients, organic compounds, macronutrients, micronutrients, penetrants, beneficial microorganisms, soil or plant additives, pesticides, fungicides, insecticides, nematicides, herbicides, and growth materials.

6. The method according to claim 5, wherein the organic material is sewage sludge, the pH modulating compound is fly ash; and the mixture comprises a 1:1 ratio of sewage sludge to fly ash to dolomite phosphate rock.

7. The method according to claim 5, wherein the beneficial microorganisms are selected from the group consisting of: Trichoderma sp., Bacillus subtilis, Penicillium spp., Bacillus sp., Bacillus popalliae, Alternaria sp., B. Thurigensis, Clostridium pasteurianum, Rhodopseudomonas capsula, Rhizobium, Bacillus megaterium, Azotobacter vinelandii, Pseudomonas fluorescens, Anthrobacter globii, Flavobacterium spp., and Saccharomyces cervisiae.

8. The method according to claim 1, wherein the mixture comprises 50-80% N-VIRO SOIL™ and 20-50% dolomite phosphate rock, wherein the resulting mixture contains 44-79 g kg⁻¹ total organic carbon (C), 3.6-6.5 g kg⁻¹ total nitrogen (N), 16-59 g kg⁻¹ total phosphorus (P), 2-3 g kg⁻¹ total potassium (K), 120-190 g kg⁻¹ calcium (Ca), and 3-8 g kg⁻¹ total magnesium (Mg).

9. The method according to claim 1, wherein the waste from phosphate-related industries is ground through a 50-150 mesh.

10. The method according to claim 1, wherein the mixture is applied to sandy, acidic soils.

11. The method according to claim 1, wherein the mixture is applied to soils for agricultural and horticultural crops selected from the group consisting of: corn, peas, oil seed rape, carrots, spring barley, avocado, citrus, mango, coffee, deciduous tree crops, grapes, strawberries and other berry crops, soybean, broad beans, commercial beans, tomato, cucurbitis, cucumis species, lettuce, potato, sugar beets, peppers, sugar cane, hops, tobacco, pineapple, coconut palm, commercial palms, ornamental palms, rubber plants, and ornamental plants.

12. A method of making a mixture for increasing the availability of nutrients in soils while controlling the release of phosphorous comprising mixing together at least one waste from phosphate-related industries and at least one organic material, wherein the waste from phosphate-related industries is selected from the group consisting of: phosphate rock, dolomite phosphate rock, phosphatic clay, and phosphate fines, and wherein the organic material is selected from the group consisting of: livestock manure, poultry manure, sewage sludge, humic acid, fulvic acid, seaweed extracts, kelp extracts, municipal composts, and organic composts.

13. The method according to claim 12, wherein about 20-50% of the mixture is composed of dolomite phosphate rock and about 50-80% of the mixture is the organic materials.

14. The method according to claim 12, further comprising the step of mixing to the mixture any one or combination of the ingredients selected from the group consisting of: companion cations, cation reducing agents, pH modulating compounds, plant nutrients, organic compounds, macronutrients, micronutrients, penetrants, beneficial microorganisms, soil or plant additives, pesticides, fungicides, insecticides, nematicides, herbicides, and growth materials.

15. The method according to claim 12, further comprising the step of grinding and passing the waste from phosphate-related industries through a 50-150 mesh before mixing the wastes from phosphate-related industries with the organic materials.

16. A product made by mixing together at least one waste from phosphate-related industries and at least one organic material, wherein the waste from phosphate-related industries is selected from the group consisting of: phosphate rock, dolomite phosphate rock, phosphatic clay, and phosphate fines, and wherein the organic material is selected from the group consisting of: livestock manure, poultry manure, sewage sludge, humic acid, fulvic acid, seaweed extracts, kelp extracts, municipal composts, and organic composts.

17. The product according to claim 16, wherein the product comprises 50-80% N-VIRO SOIL™ and 20-50% dolomite phosphate rock, wherein the product contains 44-79 g kg⁻¹ total organic carbon (C), 3.6-6.5 g kg⁻¹ total nitrogen (N), 16-59 g kg⁻¹ total phosphorus (P), 2-3 g kg⁻¹ total potassium (K), 120-190 g kg⁻¹ calcium (Ca), and 3-8 g kg⁻¹ total magnesium (Mg).

18. The product according to claim 16, further comprising any one or combination of the ingredients selected from the group consisting of: companion cations, cation reducing agents, pH modulating compounds, plant nutrient, organic compounds, macronutrients, micronutrients, penetrants, beneficial microorganisms, soil or plant additives, pesticides, fungicides, insecticides, nematicides, herbicides, and growth materials.

19. The product according to claim 18, wherein the organic material is sewage sludge, the pH modulating compound is fly ash; and the product comprises a 1:1 ratio of sewage sludge to fly ash to dolomite phosphate rock.

20. The product according to claim 18, wherein the plant nutrient is selected from the group consisting of: nitrogen (N), phosphorus (P), potassium (K), calcium (Ca), magnesium (Mg), Iron (Fe), zinc (Zn), Manganese (Mn), Copper (Cu), and Boron (B).

21. The product according to claim 16, wherein the waste from phosphate-related industries is dolomite phosphate rock that has been passed through a 50-150 mesh.

22. The product according to claim 16, wherein the product is provided in any one of the forms selected from the group consisting of: wettable powders, slow release granules, fast release granules, and controlled release formulations.

23. A composition comprising at least one waste from phosphate-related industries and at least one organic material, wherein the waste from phosphate-related industries is selected from the group consisting of: phosphate rock, dolomite phosphate rock, phosphatic clay, and phosphate fines, and wherein the organic material is selected from the group consisting of: livestock manure, poultry manure, sewage sludge, humic acid, fulvic acid, seaweed extracts, kelp extracts, municipal composts, and organic composts.

24. The composition according to claim 23 comprising 50-80% N-VIRO SOIL™ and 20-50% dolomite phosphate rock, wherein the composition contains 44-79 g kg⁻¹ total organic carbon (C), 3.6-6.5 g kg⁻¹ total nitrogen (N), 16-59 g kg⁻¹ total phosphorus (P), 2-3 g kg⁻¹ total potassium (K), 120-190 g kg⁻¹ calcium (Ca), and 3-8 g kg⁻total magnesium (Mg).

25. The composition according to claim 23, further comprising any one or combination of the ingredients selected from the group consisting of: companion cations, cation reducing agents, pH modulating compounds, plant nutrients, organic compounds, macronutrients, micronutrients, penetrants, beneficial microorganisms, soil or plant additives, pesticides, fungicides, insecticides, nematicides, herbicides, and growth materials.

26. The composition according to claim 25, wherein the organic material is sewage sludge, the pH modulating compound is fly ash; and the product comprises a 1:1 ratio of sewage sludge to fly ash to dolomite phosphate rock.

27. The composition according to claim 25, wherein the plant nutrient is selected from the group consisting of: nitrogen (N), phosphorus (P), potassium (K), calcium (Ca), magnesium (Mg), Iron (Fe), zinc (Zn), Manganese (Mn), Copper (Cu), and Boron (B).

28. The composition according to claim 23, wherein the composition is provided in any one of the forms selected from the group consisting of: wettable powders, slow release granules, fast release granules, and controlled release formulations.
